(19) United States
(12) Patent Application Publication
(10) Pub. No.: US 2025/0193860 A1
(43) Pub. Date: Jun. 12, 2025

(54) GROUP-COMMON BANDWIDTH PART SWITCHING

(71) Applicant: QUALCOMM INCORPORATED, San Diego, CA (US)

(72) Inventors: Qian Zhang, Basking Ridge, NJ (US); Yan Zhou, San Diego, CA (US); Tao Luo, San Diego, CA (US)

(21) Appl. No.: 18/843,660

(22) PCT Filed: Apr. 25, 2022
(86) PCT No.: PCT/CN2022/088984

§ 371 Date: Sep. 3, 2024

(51) Int. Cl. H04W 72/0453; H04L 5/16; H04W 72/23

(52) U.S. Cl. CPC H04W 72/0453; H04L 5/16; H04W 72/23

(57) ABSTRACT

Methods, systems, and devices for wireless communications are described. In one aspect, a network entity operating in a full-duplex mode may configure a user equipment (UE) operating in a half-duplex mode for uplink and downlink communications on a same time resource. The UE may then determine whether to receive a downlink message or transmit an uplink message on the time resource. In some examples, if the UE determines to ignore the downlink message, the UE may transmit the uplink message. Otherwise, the UE may receive the downlink message. In another aspect, a network entity may transmit a group-common downlink control information (GC-DCI) message to one or more UEs triggering a BWP switch at the UEs. Because the network entity may avoid transmitting UE-specific signaling to trigger the BWP switch, the overhead associated with triggering the BWP switch may be reduced.

### CROSS REFERENCE

The present Application is a 371 national stage filing of International PCT Application No. PCT/CN2022/088984 by Zhang et al. entitled “GROUP-COMMON BANDWIDTH PART SWITCHING,” filed Apr. 25, 2022, which is assigned to the assignee hereof, and which is expressly incorporated by reference in its entirety herein.

### FIELD OF TECHNOLOGY

The following relates to wireless communications, including group-common bandwidth part switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may include UEs and network entities capable of operating in a half-duplex mode, a full-duplex mode, or both. Improved techniques for coordinating communications between UEs and network entities supporting a half-duplex mode, a full-duplex mode, or both may be desirable.

### SUMMARY

The described techniques relate to improved methods, systems, devices, and apparatuses that support uplink and downlink multiplexing for half-duplex devices and group-common bandwidth part (BWP) switching. In one aspect, a network entity operating in a full-duplex mode may configure a user equipment (UE) operating in a half-duplex mode for uplink and downlink communications on a same time resource. The UE may then determine whether to receive a downlink message or transmit an uplink message on the time resource. In some examples, if the UE determines to ignore the downlink message, the UE may transmit the uplink message. Otherwise, the UE may receive the downlink message. In another aspect, a network entity may transmit a group-common downlink control information (DCI) message to one or more UEs triggering a BWP switch at the UEs. Because the network entity may avoid transmitting UE-specific signaling to trigger the BWP switch, the overhead associated with triggering the BWP switch may be reduced.

A method for wireless communication at a user equipment (UE) is described. The method may include communicating with a network entity on a first bandwidth part, receiving a group-common downlink control information message indicating that the UE is to communicate with the network entity on a second bandwidth part, the group-common downlink control information message being for a set of multiple UEs including the UE, and communicating with the network entity on the second bandwidth part based on receiving the group-common downlink control information message.

An apparatus for wireless communication at a UE is described. The apparatus may include a processor, memory coupled with the processor, and instructions stored in the memory. The instructions may be executable by the processor to cause the apparatus to communicate with a network entity on a first bandwidth part, receive a group-common downlink control information message indicating that the UE is to communicate with the network entity on a second bandwidth part, the group-common downlink control information message being for a set of multiple UEs including the UE, and communicate with the network entity on the second bandwidth part based on receiving the group-common downlink control information message.

Another apparatus for wireless communication at a UE is described. The apparatus may include means for communicating with a network entity on a first bandwidth part, means for receiving a group-common downlink control information message indicating that the UE is to communicate with the network entity on a second bandwidth part, the group-common downlink control information message being for a set of multiple UEs including the UE, and means for communicating with the network entity on the second bandwidth part based on receiving the group-common downlink control information message.

A non-transitory computer-readable medium storing code for wireless communication at a UE is described. The code may include instructions executable by a processor to communicate with a network entity on a first bandwidth part, receive a group-common downlink control information message indicating that the UE is to communicate with the network entity on a second bandwidth part, the group-common downlink control information message being for a set of multiple UEs including the UE, and communicate with the network entity on the second bandwidth part based on receiving the group-common downlink control information message.

Some examples of the method, apparatuses, and non-transitory computer-readable medium described herein may further include operations, features, means, or instructions for identifying, in the group-common downlink control information message, a UE-specific field for the UE indicating the second bandwidth part on which to communicate with the network entity. Some examples of the method, apparatuses, and non-transitory computer-readable medium described herein may further include operations, features, means, or instructions for identifying, in the group-common downlink control information message, a common field for the set of multiple UEs indicating the second bandwidth part on which to communicate with the network entity.

Some examples of the method, apparatuses, and non-transitory computer-readable medium described herein may further include operations, features, means, or instructions for identifying the second bandwidth part on which to communicate with the network entity based on an implicit indication of the second bandwidth part in the group-common downlink control information message. Some examples of the method, apparatuses, and non-transitory computer-readable medium described herein may further include operations, features, means, or instructions for identifying the second bandwidth part on which to communicate with the network entity based on a bandwidth part switching pattern. Some examples of the method, apparatuses, and non-transitory computer-readable medium described herein may further include operations, features, means, or instructions for receiving the group-common downlink control information message indicating that the UE may be to communicate with the network entity on the second bandwidth part based on the UE being restricted from communicating on the first bandwidth part.

In some examples of the method, apparatuses, and non-transitory computer-readable medium described herein, the UE communicates with the network entity on the first bandwidth part using frequency division duplexing in a full-duplex mode, and the UE communicates with the network entity on the second bandwidth part using time-division duplexing in a half-duplex mode. In some examples of the method, apparatuses, and non-transitory computer-readable medium described herein, the UE communicates with the network entity on the first bandwidth part using time-division duplexing in a half-duplex mode, and the UE communicates with the network entity on the second bandwidth part using frequency-division duplexing in a full-duplex mode.

A method for wireless communication at a network entity is described. The method may include communicating with a UE on a first bandwidth part, transmitting a group-common downlink control information message indicating that the UE is to communicate with the network entity on a second bandwidth part, the group-common downlink control information message being for a set of multiple UEs including the UE, and communicating with the UE on the second bandwidth part based on transmitting the group-common downlink control information message.

An apparatus for wireless communication at a network entity is described. The apparatus may include a processor, memory coupled with the processor, and instructions stored in the memory. The instructions may be executable by the processor to cause the apparatus to communicate with a UE on a first bandwidth part, transmit a group-common downlink control information message indicating that the UE is to communicate with the network entity on a second bandwidth part, the group-common downlink control information message being for a set of multiple UEs including the UE, and communicate with the UE on the second bandwidth part based on transmitting the group-common downlink control information message.

Another apparatus for wireless communication at a network entity is described. The apparatus may include means for communicating with a UE on a first bandwidth part, means for transmitting a group-common downlink control information message indicating that the UE is to communicate with the network entity on a second bandwidth part, the group-common downlink control information message being for a set of multiple UEs including the UE, and means for communicating with the UE on the second bandwidth part based on transmitting the group-common downlink control information message.

A non-transitory computer-readable medium storing code for wireless communication at a network entity is described. The code may include instructions executable by a processor to communicate with a UE on a first bandwidth part, transmit a group-common downlink control information message indicating that the UE is to communicate with the network entity on a second bandwidth part, the group-common downlink control information message being for a set of multiple UEs including the UE, and communicate with the UE on the second bandwidth part based on transmitting the group-common downlink control information message.

In some examples of the method, apparatuses, and non-transitory computer-readable medium described herein, transmitting the group-common downlink control information message may include operations, features, means, or instructions for transmitting, in the group-common downlink control information message, a UE-specific field for the UE indicating the second bandwidth part on which the UE may be to communicate with the network entity.

In some examples of the method, apparatuses, and non-transitory computer-readable medium described herein, transmitting the group-common downlink control information message may include operations, features, means, or instructions for transmitting, in the group-common downlink control information message, a common field for the set of multiple UEs indicating the second bandwidth part on which the UE may be to communicate with the network entity.

In some examples of the method, apparatuses, and non-transitory computer-readable medium described herein, the group-common downlink control information message implicitly indicates the second bandwidth part on which to communicate with the network entity. Some examples of the method, apparatuses, and non-transitory computer-readable medium described herein may further include operations, features, means, or instructions for identifying the second bandwidth part on which to communicate with the network entity based on a bandwidth part switching pattern.

In some examples of the method, apparatuses, and non-transitory computer-readable medium described herein, transmitting the group-common downlink control information message may include operations, features, means, or instructions for transmitting, in the group-common downlink control information message, the indication of the second bandwidth part on which the UE may be to communicate with the network entity based on the UE being restricted from communicating on the first bandwidth part.

In some examples of the method, apparatuses, and non-transitory computer-readable medium described herein, the UE communicates with the network entity on the first bandwidth part using frequency division duplexing in a full-duplex mode, and the UE communicates with the network entity on the second bandwidth part using time-division duplexing in a half-duplex mode. In some examples of the method, apparatuses, and non-transitory computer-readable medium described herein, the UE communicates with the network entity on the first bandwidth part using time-division duplexing in a half-duplex mode, and the UE communicates with the network entity on the second bandwidth part using frequency-division duplexing in a full-duplex mode.

### BRIEF DESCRIPTION OF THE DRAWINGS

FIG. 1 illustrates an example of a wireless communications system that supports group-common bandwidth part switching in accordance with one or more aspects of the present disclosure.

FIG. 2 illustrates an example of full-duplex communications in accordance with one or more aspects of the present disclosure.

FIG. 3 illustrates an example of full-duplex operation at a first network entity and half-duplex operation at a first user equipment (UE) and a second UE in accordance with one or more aspects of the present disclosure.

FIG. 4 illustrates an example of full-duplex operation at a first network entity and a first UE in accordance with one or more aspects of the present disclosure.

FIG. 5 illustrates an example of full-duplex operation at a first UE and half-duplex operation at a first network entity and a second network entity in accordance with one or more aspects of the present disclosure.

FIG. 6 illustrates an example of full-duplex operation at a first integrated access backhaul (IAB) node and a second IAB node in accordance with one or more aspects of the present disclosure.

FIG. 7 illustrates an example of a wireless communications system that supports uplink and downlink multiplexing for half-duplex devices in accordance with one or more aspects of the present disclosure.

FIG. 8 illustrates an example of communications based on multiplexing restriction rules in accordance with one or more aspects of the present disclosure.

FIG. 9 illustrates an example of communications based on relaxed or lifted multiplexing restriction rules in accordance with one or more aspects of the present disclosure.

FIG. 10 illustrates an example of a process flow that supports uplink and downlink multiplexing for half-duplex devices in accordance with one or more aspects of the present disclosure.

FIG. 11 illustrates an example of a wireless communications system that supports uplink and downlink multiplexing for half-duplex devices in accordance with one or more aspects of the present disclosure.

FIG. 12 illustrates an example of bandwidth part (BWP) switching in accordance with one or more aspects of the present disclosure.

FIG. 13 illustrates an example of group-common BWP switching in accordance with one or more aspects of the present disclosure.

FIG. 14 illustrates an example of a process flow that supports group-common bandwidth part switching in accordance with one or more aspects of the present disclosure.

FIGS. 15 and 16 show block diagrams of devices that support group-common bandwidth part switching in accordance with one or more aspects of the present disclosure.

FIG. 17 shows a block diagram of a communications manager that supports group-common bandwidth part switching in accordance with one or more aspects of the present disclosure.

FIG. 18 shows a diagram of a system including a device that supports group-common bandwidth part switching in accordance with one or more aspects of the present disclosure.

FIGS. 19 and 20 show block diagrams of devices that support group-common bandwidth part switching in accordance with one or more aspects of the present disclosure.

FIG. 21 shows a block diagram of a communications manager that supports group-common bandwidth part switching in accordance with one or more aspects of the present disclosure.

FIG. 22 shows a diagram of a system including a device that supports group-common bandwidth part switching in accordance with one or more aspects of the present disclosure.

FIGS. 23 and 24 show flowcharts illustrating methods that support group-common bandwidth part switching in accordance with one or more aspects of the present disclosure.

### DETAILED DESCRIPTION

Some wireless communications systems may include user equipments (UEs) and network entities capable of operating in a half-duplex mode, a full-duplex mode, or both. In such systems, it may be challenging to coordinate communications between the UEs and the network entities.

In one aspect, a UE operating in a half-duplex mode may communicate with a network entity operating in a full-duplex mode. To ensure that the UE is not scheduled to simultaneously transmit and receive, the UE may be configured to operate in accordance with multiple multiplexing restriction rules. These multiplexing restriction rules may prevent the UE from simultaneously transmitting uplink transmissions to a network entity and receiving downlink transmissions from the network entity. In some cases, however, these multiplexing restriction rules may affect throughput if resources are underutilized (e.g., when the UE ignores a downlink message and still avoids transmitting an uplink message).

In another aspect, a network entity may be capable of operating in a half-duplex mode or a full-duplex mode when communicating with one or more UEs. In some examples, the network entity may operate in a full-duplex mode and, in the presence of strong self-interference, the network entity may fall back to a half-duplex mode. In some cases, the size of a bandwidth part (BWP) used by the network entity to communicate while in a full-duplex mode may be different from the size of a BWP used by the network entity to communicate while in a half-duplex mode. Thus, if the network entity determines to switch from communicating in a full-duplex mode to communicating in a half-duplex mode, the network entity may trigger a BWP switch at one or more UEs with which the network entity is communicating. In some cases, however, the overhead associated with using existing, UE-specific signaling to trigger BWP switching may be high.

The techniques described herein provide for efficiently coordinating communications between UEs and network entities supporting a half-duplex mode, a full-duplex mode, or both. In one aspect, a network entity operating in a full-duplex mode may configure a UE operating in a half-duplex mode for uplink and downlink communications on a same time resource. The UE may then determine whether to receive a downlink message or transmit an uplink message on the time resource. In some examples, if the UE determines to ignore the downlink message, the UE may transmit the uplink message. Otherwise, the UE may receive the downlink message. In another aspect, a network entity may transmit a group-common downlink control information (GC-DCI) message to one or more UEs triggering a BWP switch at the UEs. Because the network entity may avoid transmitting UE-specific signaling to trigger the BWP switch, the overhead associated with triggering the BWP switch may be reduced.

Aspects of the disclosure are initially described in the context of wireless communications systems. Examples of processes and signaling exchanges that support uplink and downlink multiplexing for half-duplex devices and group-common BWP switching are then described. Aspects of the disclosure are further illustrated by and described with reference to apparatus diagrams, system diagrams, and flowcharts that relate to uplink and downlink multiplexing for half-duplex devices and group-common BWP switching.

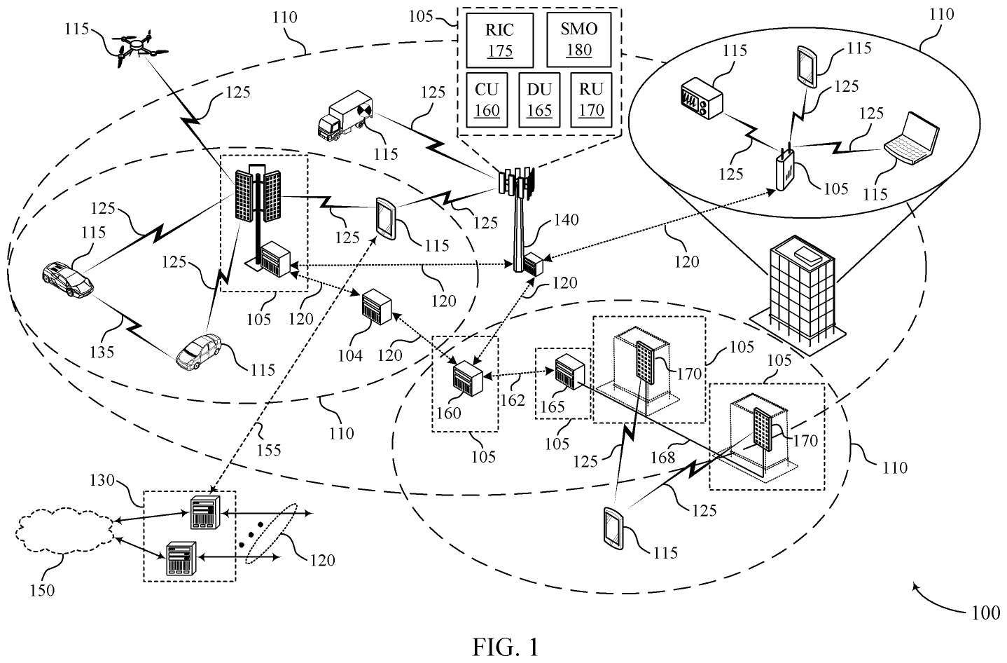

FIG. 1 illustrates an example of a wireless communications system 100 that supports group-common bandwidth part switching in accordance with one or more aspects of the present disclosure. The wireless communications system 100 may include one or more network entities 105, one or more UEs 115, and a core network 130. In some examples, the wireless communications system 100 may be a Long-Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink and downlink multiplexing for half-duplex devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115 (e.g., physical downlink control channel (PDCCH), physical downlink shared channel (PDSCH), or channel state information reference signal (CSI-RS) transmissions), uplink transmissions (e.g., return link transmissions) from a UE 115 to a network entity 105 (e.g., physical uplink control channel (PUCCH), physical uplink shared channel (PUSCH), physical random-access channel (PRACH), or sounding reference signal (SRS) transmissions), or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Af) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna array's within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

Some UEs 115 or network entities 105 in wireless communications system 100 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the network entities 105 or UEs 115 include entering a power saving deep sleep mode when not engaging in active communications, operating over a limited bandwidth (e.g., according to narrow band communications), or a combination of these techniques. For example, some network entities 105 or UEs 115 may be configured for operation using a narrow band protocol type that is associated with a defined portion or range (e.g., set of subcarriers or resource blocks (RBs)) within a carrier, within a guard-band of a carrier, or outside of a carrier.

In addition to, or as an alternative to, a half-duplex mode, some network entities 105 or UEs 115 may support a full-duplex mode. A full-duplex mode may refer to a mode that supports two-way communication via simultaneous transmission and reception. This two-way communication may be referred to as full-duplex communications. Full-duplex communications is a technique which is capable of theoretically doubling link capacity by enabling radio network nodes to transmit and receive simultaneously on the same frequency and time resource. Full-duplex breaks half-duplex operation constraints where transmission and reception either differ in time or in frequency. A full-duplex network node, such as a network entity 105, UE 115, or both in the cellular network, can communicate simultaneously in uplink and downlink with two half-duplex panels using the same radio resources. For instance, a UE 115 may transmit uplink transmissions from one panel at the UE 115, and the UE 115 may receive downlink transmissions at another panel at the UE 115. Similarly, a network entity 105 may receive uplink transmissions at one panel at the network entity 105, and the network entity 105 may transmit downlink transmissions from another panel at the network entity 105.

Thus, a device equipped with multiple TRPs that supports the capability of simultaneous transmission and reception using the same time-frequency radio resource (e.g., uplink or downlink transmissions in frequency range 2 (FR2) and different associated aspects of procedures) may be referred to as a full-duplex capable device (e.g., full-duplex UE 115 or full-duplex network entity 105). The device may also be capable of working in both the full-duplex mode and backing off to a half-duplex mode. In some cases, a full-duplex capability may be conditional on beam separation and other factors (e.g., self-interference between downlink and uplink and clutter echo at a device). However, full-duplex communications may provide for latency reduction (e.g., since it may be possible to receive a downlink signal in an uplink-only slot, which may enable latency savings), spectrum efficiency enhancement (e.g., per cell or per UE 115), more efficient resource utilization, and coverage enhancements with continuous uplink or downlink transmissions or repetitions.

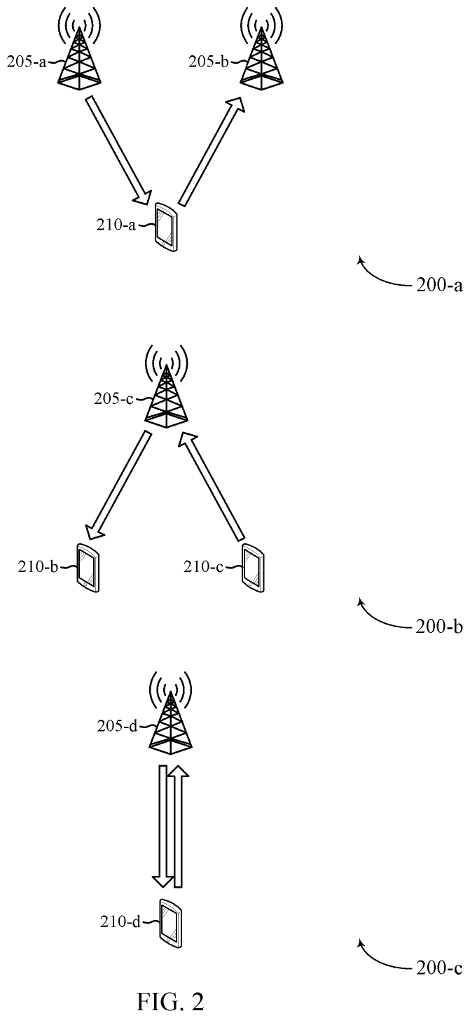

FIG. 2 illustrates an example of full-duplex communications 200 in accordance with one or more aspects of the present disclosure. In a first example 200-a, a UE 210-a may support full-duplex communications (e.g., operate in a full-duplex mode), and the UE 210-a may receive downlink signals from a first network entity 205-a (e.g., cell or transmission and reception point (TRP)) and transmit uplink signals to a second network entity 205-b. The first example 200-a may be an example of multi-TRP communications. In a second example 200-b, a network entity 205-c may support full-duplex communications (e.g., operate in a full-duplex mode), and the network entity 205-c may transmit downlink signals to a first UE 210-b and receive uplink signals from a second UE 210-c. In a third example 200-c, a network entity 205-d and a UE 210-d may each support full-duplex communications (e.g., operate in a full-duplex mode). The network entity 205-d may transmit downlink signals to the UE 210-d and receive uplink signals from the UE 210-d, and the UE 210-d may receive downlink signals from the network entity 205-d and transmit uplink signals to the network entity 205-d.

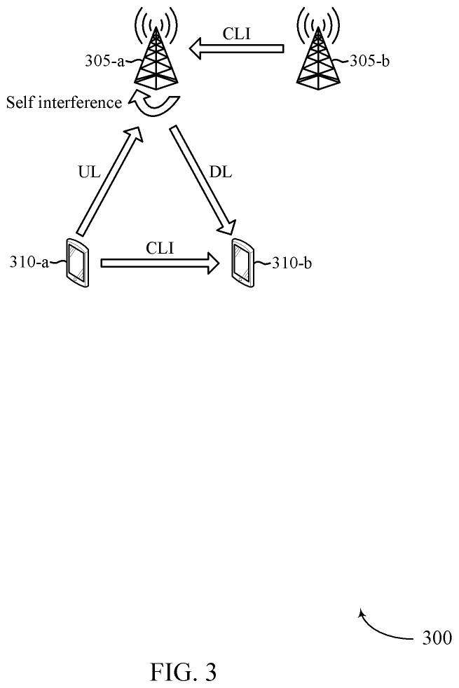

FIG. 3 illustrates an example of full-duplex operation 300 at a first network entity 305-a and half-duplex operation at a first UE 310-a and a second UE 310-b in accordance with one or more aspects of the present disclosure. The first network entity 305-a may receive uplink transmission from the first UE 310-a and transmit downlink transmissions to the second UE 310-b. The second UE 310-b may experience CLI from the uplink transmissions from the first UE 310-a, and the first network entity 305-a may experience CLI from a second network entity 305-b. The first network entity 305-a may also experience self-interference from full-duplex operation since the first network entity 305-a may simultaneously receive uplink transmissions from the first UE 310-a and transmit downlink transmissions to the second UE 310-b.

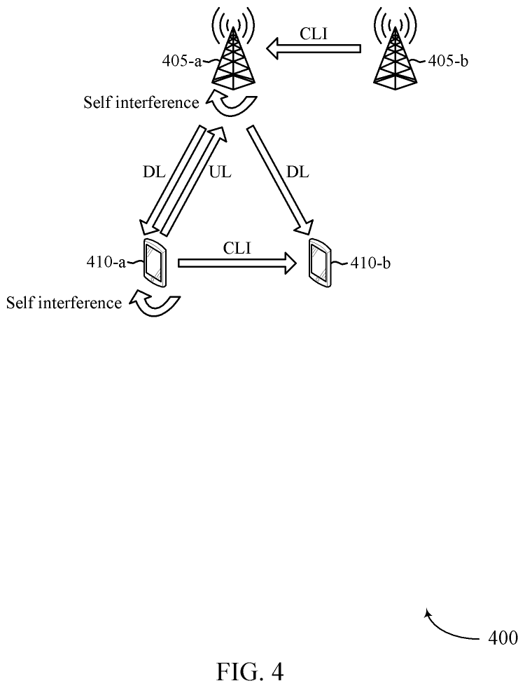

FIG. 4 illustrates an example of full-duplex operation 400 at a first network entity 405-a and a first UE 410-a (e.g., a customer premises equipment (CPE)) in accordance with one or more aspects of the present disclosure. The first network entity 405-a may communicate with the first UE 410-a and the second UE 410-b with partially overlapping uplink and downlink transmissions. The second UE 410-b may experience CLI from the uplink transmissions from the first UE 410-a, and the first network entity 405-a may experience CLI from a second network entity 405-b. The first network entity 405-a may also experience self-interference from full-duplex operation since the first network entity 405-a may simultaneously receive uplink transmissions from the first UE 410-a and transmit downlink transmissions to the first UE 410-a and the second UE 410-b. The first UE 410-a may also experience self-interference from full-duplex operation since the first UE 410-a may simultaneously receive downlink transmissions from the first network entity 405-a and transmit uplink transmissions to the first network entity 405-a.

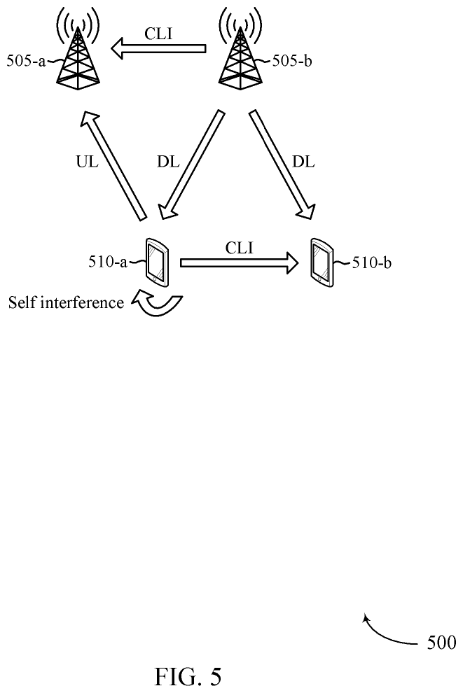

FIG. 5 illustrates an example of full-duplex operation 500 at a first UE 510-a and half-duplex operation at a first network entity 505-a and a second network entity 505-b in accordance with one or more aspects of the present disclosure. The first network entity 505-a and the second network entity 505-b may support multi transmission and reception point (multi-TRP) transmissions to the first UE 510-a (e.g., with fully overlapping uplink and downlink transmission). A second UE 510-b may experience CLI from uplink transmissions from the first UE 510-a, and the first network entity 505-a may experience CLI from downlink transmissions from the second network entity 505-b. The first UE 510-a may experience self-interference from full-duplex operation since the first UE 510-a may simultaneously receive downlink transmissions from the first network entity 505-a and the second network entity 505-b and transmit uplink transmissions to the first network entity 505-a.

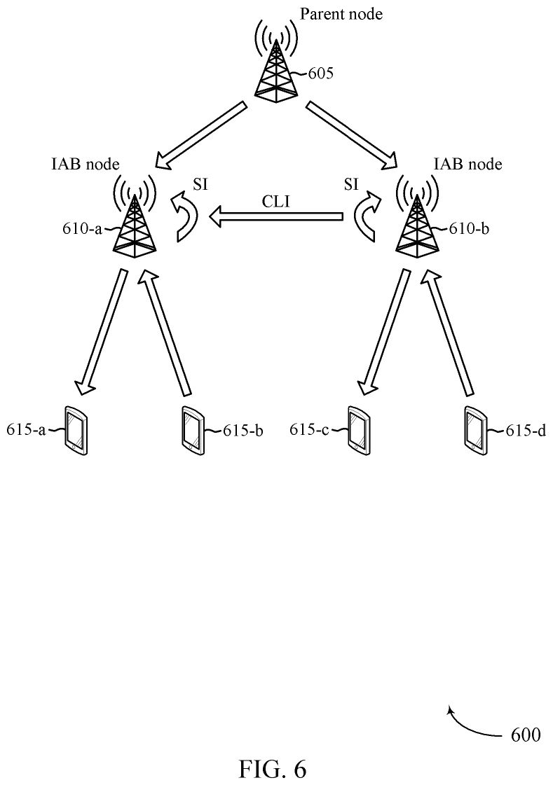

FIG. 6 illustrates an example of full-duplex operation 600 at a first IAB node 610-a and a second IAB node 610-b (e.g., enhanced duplexing capability) in accordance with one or more aspects of the present disclosure. The first IAB node 610-a and the second IAB node 610-b may share a parent node 605. The first IAB node 610-a may transmit downlink transmissions to a first UE 615-a and receive uplink transmissions from a second UE 615-b. The second IAB node 610-b may transmit downlink transmissions to a third UE 615-c and receive uplink transmissions from a fourth UE 615-d. The first IAB node 610-a may experience CLI from downlink transmissions from the second IAB node 610-b. The first IAB node 610-a may also experience self-interference from full-duplex operation since the first IAB node 610-a may simultaneously transmit downlink transmissions to the first UE 615-a and receive uplink transmissions from the second UE 615-b. Similarly, the second IAB node 610-b may experience self-interference from full-duplex operation since the second IAB node 610-b may simultaneously transmit downlink transmissions to the third UE 615-c and receive uplink transmissions from the fourth UE 615-d. In some cases, the first IAB node 610-a and the second IAB node 610-b may both support single frequency full-duplex (SFFD) and FDM or spatial division multiplexing (SDM) with resource block group (RBG) granularity.

The examples described with reference to FIGS. 3-6 may be implemented in the wireless communications system 100. Thus, the wireless communications system 100 may include UEs 115 and network entities 105 capable of operating in a half-duplex mode, a full-duplex mode, or both. In some cases, it may be challenging to coordinate communications between the UEs 115 and the network entities 105. The wireless communications system 100 may support efficient techniques for coordinating communications between UEs 115 and network entities 105 supporting a half-duplex mode, a full-duplex mode, or both.

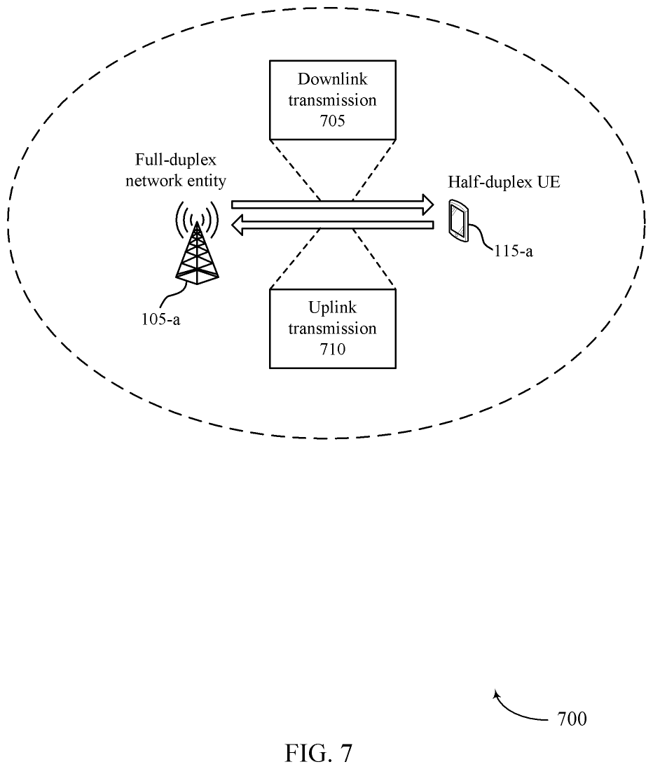

FIG. 7 illustrates an example of a wireless communications system 700 that supports uplink and downlink multiplexing for half-duplex devices in accordance with one or more aspects of the present disclosure. The wireless communications system 700 includes a UE 115-a, which may be an example of a UE described with reference to FIGS. 1-6. The wireless communications system 700 also includes a network entity 105-a, which may be an example of a network entity described with reference to FIGS. 1-6. The wireless communications system 700 may implement aspects of the wireless communications system 100. For example, the wireless communications system 700 may support efficient techniques for coordinating communications between the UE 115-a operating in a half-duplex mode and the network entity 105-a operating in a full-duplex mode.

Although the network entity 105-a may operate in the full-duplex mode, the UE 115-a may operate in the half-duplex mode and may not support full-duplex communications with the network entity 105-a. For instance, in some wireless communications systems, to ensure that the UE 115-a is not scheduled to simultaneously transmit and receive, the UE 115-a may be configured to operate in accordance with multiple multiplexing restriction rules. That is, downlink or uplink channel or reference signal multiplexing restriction rules in a time domain may be introduced. The multiplexing restriction rules may apply

In one example, the multiplexing restriction rules may provide that a half-duplex UE 115 does not transmit PUSCH, PUCCH, PRACH, or SRS transmissions on synchronization signal block (SSB) symbols. In another example, the multiplexing restriction rules may provide that a half-duplex UE 115 does not receive PDCCH, PDSCH, or CSI-RS transmissions on valid random-access occasion (RO) and corresponding gap symbols. In yet another example, the multiplexing restriction rules may provide that a half-duplex UE 115 does not receive PDCCH, PDSCH, or CSI-RS transmissions on RRC uplink symbols (e.g., both common and dedicated). In yet another example, the multiplexing restriction rules may provide that a half-duplex UE 115 does not transmit PUCCH, PUSCH, PRACH, or SRS transmissions on RRC downlink symbols (e.g., both common and dedicated). In yet another example, the multiplexing restriction rules may provide that a half-duplex UE 115 does not expect to have both dedicated configured reception and transmission on a same RRC flexible symbol. Each of the above examples may apply for communications on different component carriers (e.g., across component carriers) or at least on a same band.

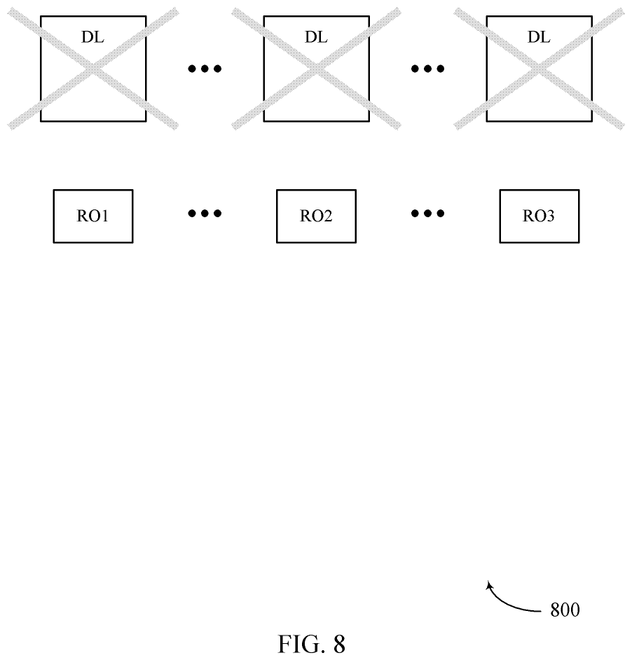

FIG. 8 illustrates an example of communications 800 based on multiplexing restriction rules in accordance with one or more aspects of the present disclosure. As shown, a half-duplex UE 115 may avoid receiving downlink transmissions and transmitting uplink transmissions in valid random-access occasions.

These multiplexing restriction rules may prevent a half-duplex UE 115 from simultaneously transmitting uplink transmissions to a network entity 105 and receiving downlink transmissions from the network entity 105. In some cases, however, these multiplexing restriction rules may affect throughput if resources are underutilized (e.g., when the UE ignores a downlink message and still avoids transmitting an uplink message). The multiplexing restriction rules may also affect overhead if bandwidth is not fully utilize for SSB transmissions, random-access occasions, etc. (e.g., since some downlink transmissions may be ignored and uplink transmissions may be avoided). In an example, a PRACH preamble duration may range from 142 us (e.g., format CO) to 3.5 ms (e.g., format 2) with a bandwidth of a few MHz, and a UE 115 may use additional resources to transmit the PRACH preamble even if a downlink transmission during a valid random-access occasion is ignored by the UE 115.

To improve throughput and minimize overhead, reduce a downlink to uplink switching delay, and reduce latency, the downlink or uplink channel or reference signal multiplexing restriction rules may be relaxed or lifted in wireless communications system 700 for the half-duplex UE 115-a communicating with the full-duplex network entity 105-a. For instance, the full-duplex network entity 105-a may configure or schedule the half-duplex UE 115-a to receive a downlink transmission 705 and transmit an uplink transmission 710 on a same time resource.

In one example, the half-duplex UE 115-b may be scheduled with PUSCH, PUCCH, PRACH, or SRS on SSB symbols. In another example, the half-duplex UE 115-b may be scheduled with PDCCH, PDSCH, or CSI-RS on valid random-access occasion and corresponding gap symbols. In yet another example, the half-duplex UE 115-b may be scheduled with PDCCH, PDSCH, or CSI-RS on RRC uplink symbols (e.g., both common and dedicated). In yet another example, the half-duplex UE 115-b may be scheduled with PUCCH, PUSCH, PRACH, or SRS on RRC downlink symbols (e.g., both common and dedicated). In yet another example, the half-duplex UE 115-b may be configured with both dedicated configured reception and transmission on the same RRC flexible symbols.

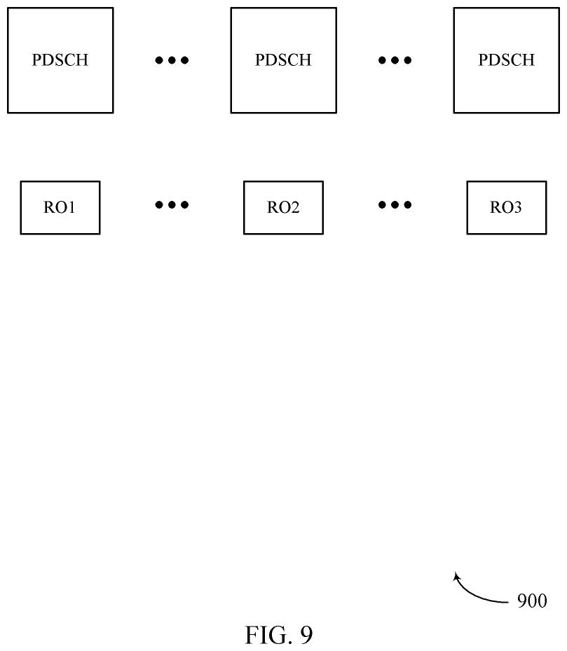

FIG. 9 illustrates an example of communications 900 based on relaxed or

lifted multiplexing restriction rules in accordance with one or more aspects of the present disclosure. As shown, a half-duplex UE 115 may be configured or scheduled to receive downlink transmissions and transmit uplink transmissions in valid random-access occasions.

Because the half-duplex UE 115-a may be configured or scheduled for downlink communications and uplink communications on a time resource (e.g., a same time resource), the half-duplex UE 115-a may ignore a downlink transmission from the network entity 105-a on the time resource and transmit an uplink transmission to the network entity 105-a on the time resource. The half-duplex UE 115-a may also be configured to determine whether to receive a downlink message from the network entity 105-a on a time resource or transmit an uplink message to the network entity 105-a on the same time resource. That is, the wireless communications system 700 may define a prioritization rule for downlink or uplink channels or reference signals on the same symbol. In an example, when a PDSCH is multiplexed with a random-access occasion, the PDSCH may be prioritized if the UE 115-a has not initiated a random-access channel (RACH) procedure on this random-access occasion (e.g., RACH for BFR). Otherwise, the UE 115-a may prioritize the RACH procedure on this random-access occasion, and the PDSCH is ignored.

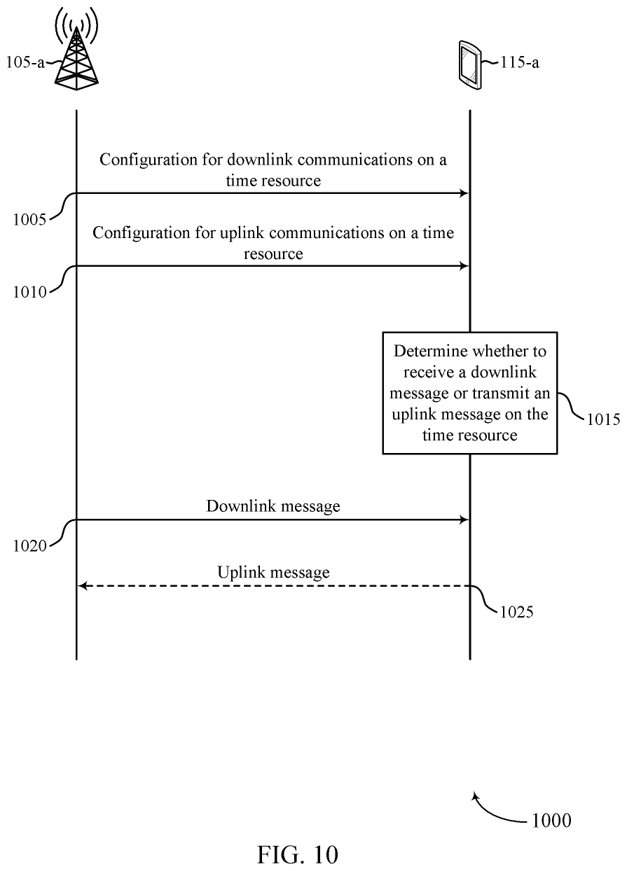

FIG. 10 illustrates an example of a process flow 1000 that supports uplink and downlink multiplexing for half-duplex devices in accordance with one or more aspects of the present disclosure. Process flow 1000 includes a UE 115-a, which may be an example of a UE described with reference to FIGS. 1-9. Process flow 1000 also includes a network entity 105-a, which may be an example of a network entity described with reference to FIGS. 1-9. The process flow 1000 may implement aspects of wireless communications system 700. For example, the process flow 1000 may support efficient techniques for coordinating communications between the UE 115-a operating in a half-duplex mode and the network entity 105-a operating in a full-duplex mode.

In the following description of the process flow 1000, the signaling exchanged between UE 115-a and network entity 105-a may be exchanged in a different order than the example order shown, or the operations performed by UE 115-a and network entity 105-a may be performed in different orders or at different times. Some operations may also be omitted from the process flow 1000, and other operations may be added to the process flow 1000.

At 1005, the network entity 105-a may transmit, and the UE 115-a may receive, an indication of a first configuration for utilizing at least one time resource for downlink communications. At 1010, the network entity 105-a may transmit, and the UE 115-a may receive, an indication of a second configuration for utilizing the same at least one time resource for uplink communications. At 1015, the UE 115-a may determine whether to receive a downlink message or transmit an uplink message on the at least one time resource based on the first configuration, the second configuration, and the UE 115-a operating in the half-duplex mode. In some cases, the determining may be based on the network entity operating in the full-duplex mode. The UE 115-a may then communicate with the network entity 105-a in accordance with the determining.

At 1020, the network entity 105-a may transmit the downlink message to the UE 115-a. The UE 115-a may then determine whether to receive the downlink message. If the UE 115-a determines to receive the downlink message, the UE 115-a may receive the downlink message and avoid transmitting the uplink message on the at least one time resource. If the UE 115-a determines to ignore the downlink message, the UE 115-a may transmit the uplink message at 1025. In some cases, the network entity 105-a may transmit the downlink message and monitor for the uplink message since the network entity 105-a is operating in the full-duplex mode. Thus, the UE 115-a may either monitor for the downlink message or transmit the uplink message, while the network entity 105-a may transmit the downlink message and monitor for the uplink message.

In some cases, the UE 115-a may determine whether to receive the downlink message or transmit the uplink message based on a first priority associated with the downlink message and a second priority associated with the uplink message. The first priority associated with the downlink message may be based on an active transmission configuration indication (TCI) state at the UE 115-a and whether the UE 115-a is to perform a beam management procedure at the UE 115-a. For instance, if the downlink message includes an SSB unassociated with the active TCI state at the UE 115-a, the UE 115-a may determine to ignore the downlink message. Alternatively, if the UE 115-a does not intend to perform a beam management procedure, the UE 115-a may determine to ignore the downlink message (e.g., an SSB). The second priority associated with the uplink message may be based on a latency requirement associated with the uplink message. For instance, if the uplink message is a part of URLLC traffic, the UE 115-a may prioritize transmitting the uplink message over receiving the downlink message.

In some cases, if the UE 115-a has not initiated a random-access procedure (e.g., where the at least one time resource allocated for downlink and uplink communications includes a valid random-access occasion), the UE 115-a may receive the downlink message on the at least one time resource. Alternatively, if the UE 115-a has initiated a random-access procedure (e.g., where the at least one time resource allocated for downlink and uplink communications includes a valid random-access occasion), the UE 115-a may transmit the uplink message on the at least one time resource. In some examples, the downlink message may include an SSB, and the uplink message may include a data message (e.g., PUSCH message), a control information message (e.g., PUCCH message), a random-access message (e.g., a PRACH message), or an SRS. In some examples, the downlink message may include a data message (e.g., PDSCH message), a control information message (e.g., PDCCH message), or a CSI-RS, and the uplink message may include a random-access message (e.g., PRACH message), where the at least one time resource is a valid random-access occasion.

In some cases, the network entity 105-a may transmit, and the UE 115-a may receive, RRC signaling configuring the at least one time resource for uplink, where the downlink message scheduled on the at least one time resource includes a data message (e.g., PDSCH message), a control information message (e.g., PDCCH message), or a CSI-RS. In some cases, the network entity 105-a may transmit, and the UE 115-a may receive, RRC signaling configuring the at least one time resource for downlink, where the uplink message scheduled on the at least one time resource includes a data message (e.g., a PUSCH message), a control information message (e.g., PUCCH message), a random-access message (e.g., PRACH message), or an SRS. In some examples, the at least one time resource may include a flexible time resource configured for either uplink or downlink.

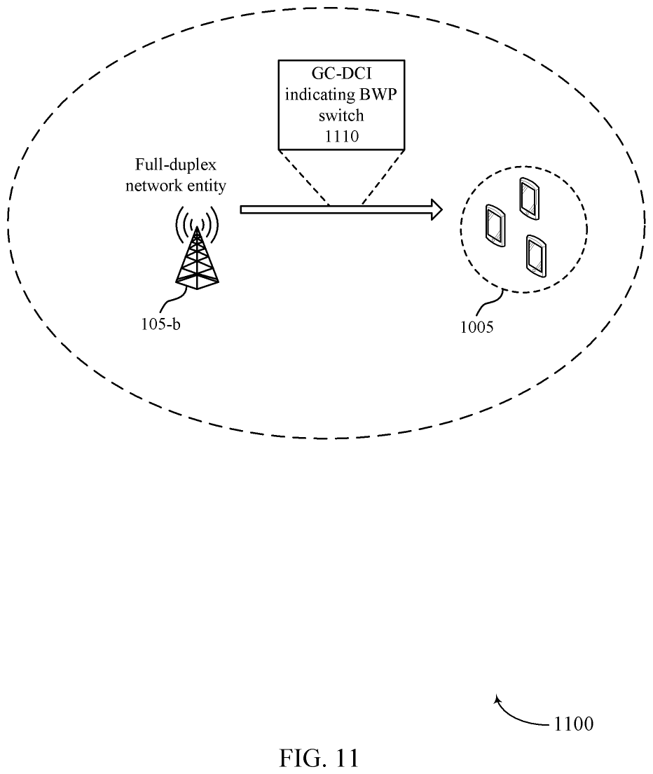

FIG. 11 illustrates an example of a wireless communications system 1100 that supports group-common bandwidth part switching in accordance with one or more aspects of the present disclosure. The wireless communications system 1100 includes a group of UEs 1105, and each UE 115 in the group may be an example of a UE described with reference to FIGS. 1-10. The wireless communications system 1100 also includes a network entity 105-b, which may be an example of a network entity described with reference to FIGS. 1-10. The wireless communications system 1100 may implement aspects of the wireless communications system 100. For example, the wireless communications system 1100 may support efficient techniques for coordinating communications between the network entity 105-b supporting a half-duplex mode and a full-duplex mode and a group of UEs 1105.

Although the network entity 105-b may be capable of operating in the full-duplex mode and may support full-duplex communications, in some cases, it may be appropriate for the network entity 105-b to operate in the half-duplex mode. For instance, in the presence of strong self-interference at the network entity 105-b, the network entity 105-b may prefer to switch full-duplex scheduling to half-duplex scheduling, which may involve an active BWP change per UE 115. When the network entity 105-b is operating in a full-duplex mode and is communicating using FDM, the uplink and downlink BWPs used by the network entity 105-b to communicate with each UE 115 in the group of UEs 1105 may be narrower than a full bandwidth to save power. However, when the network entity 105-b is operating in a half-duplex mode, the uplink and downlink BWPs used by the network entity 105-b to communicate with each UE 115 in the group of UEs 1105 may span the full bandwidth to fully utilize a spectrum.

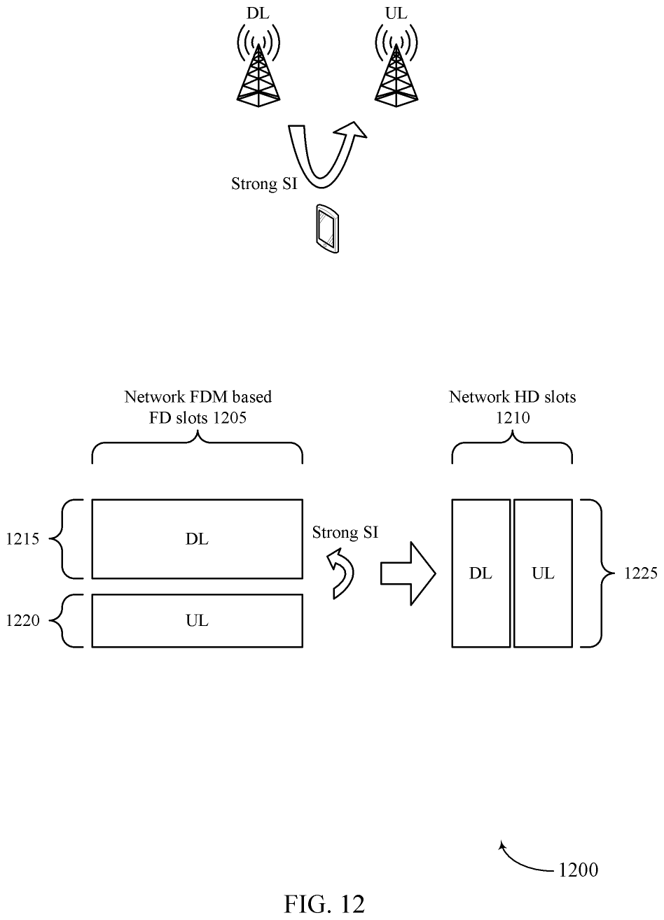

FIG. 12 illustrates an example of BWP switching 1200 in accordance with one or more aspects of the present disclosure. The network entity 105-b may experience strong self-interference and may switch from communicating using network FDM-based full-duplex slots 1205 and may communicate using network half-duplex slots 1210. That is, the network entity 105-b may prefer half-duplex communications when experiencing strong self-interference. When switching from communicating using full-duplex to communicating using half-duplex, the network entity 105-b may also switch the BWP used for communicating. For downlink communications, the network entity 105-b may switch from communicating on BWP 1215 to communicating using BWP 1225. For uplink communications, the network entity 105-b may switch from communicating on BWP 1220 to communicating using BWP 1225.

Thus, if the network entity 105-b determines to switch from communicating in a full-duplex mode to communicating in a half-duplex mode, the network entity may determine to trigger a BWP switch at the group of UEs 1105 with which the network entity 105-b is communicating. In some cases, however, active BWP switching may be UE-specific via a BWP indicator field in non-fallback DCI formats, and the overhead associated with using existing, UE-specific signaling to trigger BWP switching may be high. That is, active BWP switching using UE-specific signaling may not be overhead efficient if the network entity 105-b prefers to change the BWP used for communicating with a group of UEs 1105 (e.g., which may suffer from the strong self-interference at the network entity 105-b).

The wireless communications system 1100 may support efficient techniques for facilitating BWP switching from a first BWP to a second BWP when a network entity 105-b switches from communicating using full-duplex to communicating using half-duplex.

According to various aspects described herein, GC-DCI 1110 may be introduced for BWP switching for a group of UEs 1105 (e.g., UEs 115 with which the network entity 105-b communicates using the same SSB beam). The GC-DCI 1110 may carry downlink or uplink active BWP fields for each UE 115 in the group of UEs 1105, or the GC-DCI 1110 may carry common downlink or uplink active BWP fields for all UEs 115 in the group of UEs 1105. In some examples, the GC-DCI 1110 may implicitly activate or reactivate semi-persistent downlink or uplink transmission for the second BWP (e.g., new BWPs) per UE 115 (e.g., similar to semi-persistent scheduling (SPS) or a type 2 configured grant). If any of the UEs 115 in the group of UEs 1105 lack support for BWP switching using the GC-DCI 1110, the network entity 105-b may use BWP signaling to trigger BWP switching or reuse half-duplex BWPs for full-duplex. In some examples, a predetermined half-duplex or full-duplex BWP switching pattern may be configured as well for the group of UEs 1105, which may implicitly activate or reactivate semi-persistent downlink or uplink transmissions configured for the second BWP per UE 115 (e.g., similar to SPS or a type 2 configured grant).

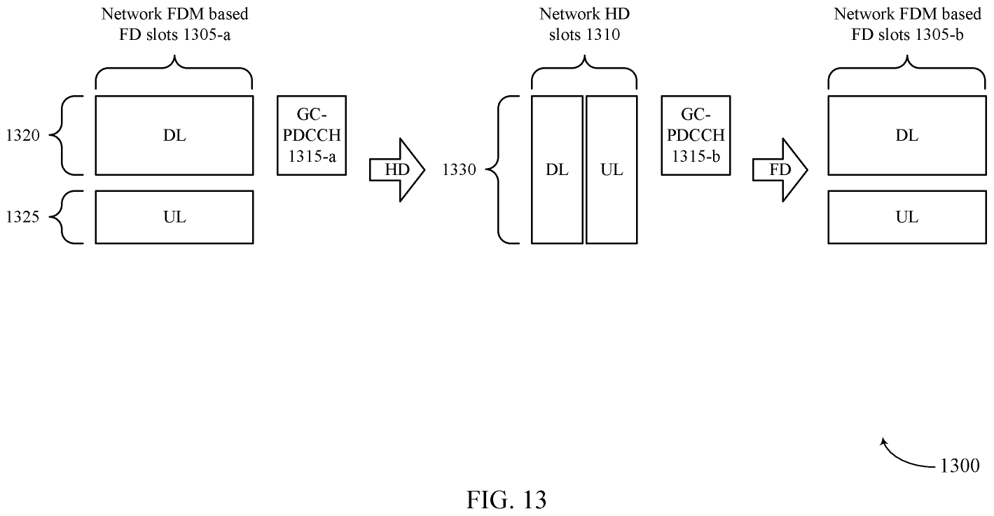

FIG. 13 illustrates an example of group-common BWP switching 1300 in accordance with one or more aspects of the present disclosure. The network entity 105-b may communicate with the group of UEs 1105 using the network FDM-based full-duplex slots 1305-a and may experience strong self-interference. Thus, the network entity 105-b may determine to switch to communicating with the group of UEs 1105 using the network half-duplex slots 1310. The network entity 105-b may transmit GC-DCI on the GC-PDCCH 1315-a to trigger a BWP switch from communicating using full-duplex to communicating using half-duplex. For downlink communications, the GC-DCI may trigger a BWP switch from a BWP 1320 to a BWP 1330, and, for uplink communications, the GC-DCI may trigger a BWP switch from a BWP 1325 to the BWP 1330.

After some time, the network entity 105-b may determine to switch from communicating using the network half-duplex slots 1310 to communicating using the network FDM-based full-duplex slots 1305-b. The network entity 105-b may then transmit a GC-DCI on the GC-PDCCH 1315-b to trigger a BWP switch from communicating using half-duplex to communicating using full-duplex. For downlink communications, the GC-DCI may trigger a BWP switch from the BWP 1330 to the BWP 1320, and, for uplink communications, the GC-DCI may trigger a BWP switch from the BWP 1330 to the BWP 1320.

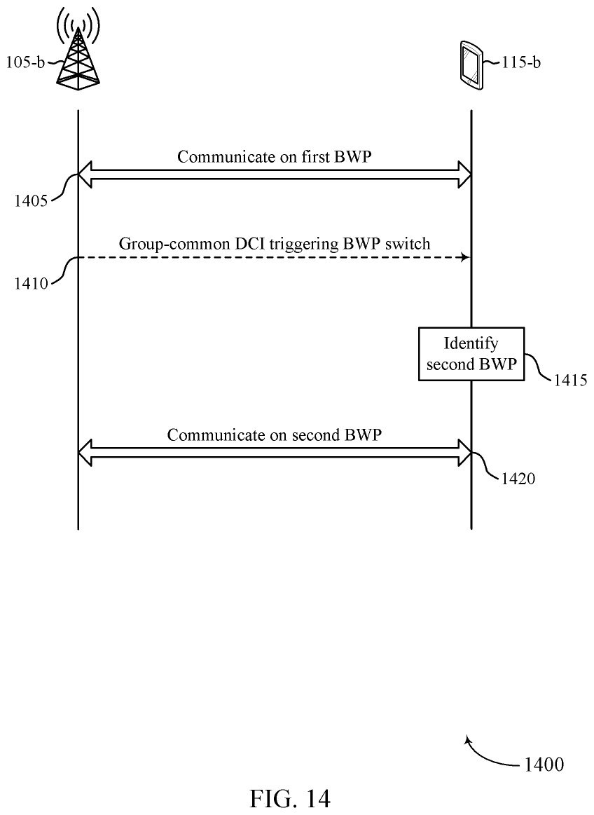

FIG. 14 illustrates an example of a process flow 1400 that supports group-common bandwidth part switching in accordance with one or more aspects of the present disclosure. Process flow 1400 includes a UE 115-b, which may be an example of a UE 115 described with reference to FIGS. 1-13. Process flow 1400 also includes a network entity 105-b, which may be an example of a network entity 105 described with reference to FIGS. 1-13. The process flow 1400 may implement aspects of wireless communications system 1100. For example, the process flow 1400 may support efficient techniques for coordinating communications between the UE 115-a operating in a half-duplex mode and the network entity 105-a operating in a full-duplex mode.

In the following description of the process flow 1400, the signaling exchanged between UE 115-b and network entity 105-b may be exchanged in a different order than the example order shown, or the operations performed by UE 115-b and network entity 105-b may be performed in different orders or at different times. Some operations may also be omitted from the process flow 1400, and other operations may be added to the process flow 1400.

At 1405, the UE 115-b may communicate with the network entity 105-b on a first BWP. At 1410, the network entity 105-b may transmit, and the UE 115-b may receive, a GC-DCI message indicating that the UE 115-b is to communicate with the network entity 105-b on a second BWP. The GC-DCI may be for multiple UEs 115 including the UE 115-b. In some cases, the UE 115-b may receive the GC-DCI indicating that the UE 115-b is to communicate with the network entity 105-b on the second BWP based on the UE 115-b being restricted from communicating on the first BWP. At 1415, the UE 115-b may identify the second BWP on which to communicate with the network entity 105-b based on the GC-DCI. At 1420, the UE 115-b may then communicate with the network entity 105-b on the second BWP based on receiving the GC-DCI message.

In some examples, the network entity may be triggered to perform BWP switching based on switching from communicating in a full-duplex mode to a half-duplex mode or vice versa. For instance, the UE 115-b may communicate with the network entity 105-b on the first BWP using FDD in a full-duplex mode, and the UE 115-b may communicate with the network entity 105-b on the second BWP using TDD in a half-duplex mode. Alternatively, the UE 115-b may communicate with the network entity 105-b on the first BWP using TDD in a half-duplex mode, and the UE 115-b may communicate with the network entity 105-b on the second BWP using FDD in a full-duplex mode.

In some examples, the UE 115-b may identify, in the GC-DCI message, a UE-specific field for the UE 115-b indicating the second BWP on which to communicate with the network entity 105-b. In some examples, the UE 115-b may identify, in the GC-DCI message, a common field for the multiple UEs indicating the second BWP on which to communicate with the network entity 105-b. In some examples, the UE 115-b may identify the second BWP on which to communicate with the network entity 105-b based on an implicit indication of the second BWP in the GC-DCI message. For instance, the GC-DCI may not explicitly indicate the second BWP, but the UE 115-b may identify the second BWP based on receiving the GC-DCI. In some examples, the UE 115-b may identify the second BWP on which to communicate with the network entity 105-b based on a BWP switching pattern. For instance, if the UE 115-b is communicating with the network entity 105-b on the first BWP, the BWP switching pattern may indicate that the UE 115-b is to communicate with the network entity on the second BWP after receiving the GC-DCI.

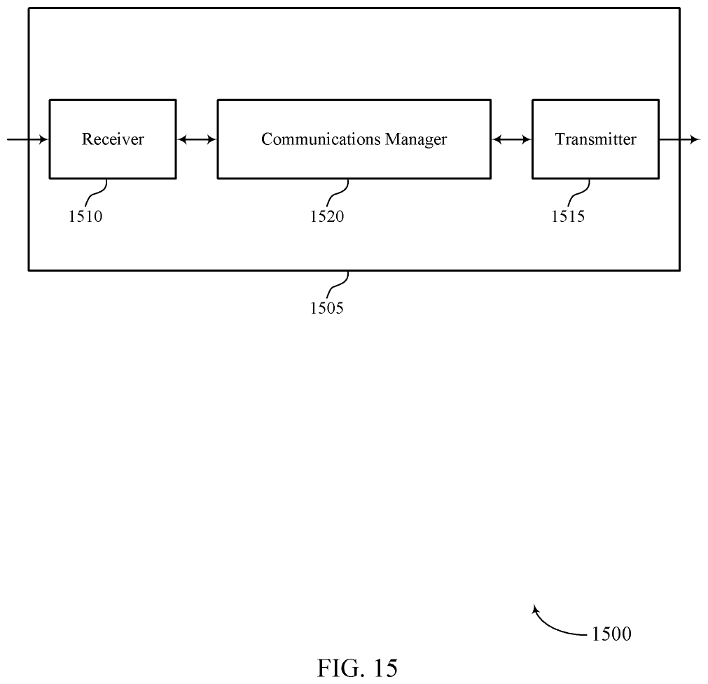

FIG. 15 shows a block diagram 1500 of a device 1505 that supports group-common bandwidth part switching in accordance with one or more aspects of the present disclosure. The device 1505 may be an example of aspects of a UE 115 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for receiving information such as packets, user data, control information, or any combination thereof associated with various information channels (e.g., control channels, data channels, information channels related to group-common bandwidth part switching). Information may be passed on to other components of the device 1505. The receiver 1510 may utilize a single antenna or a set of multiple antennas.

The transmitter 1515 may provide a means for transmitting signals generated by other components of the device 1505. For example, the transmitter 1515 may transmit information such as packets, user data, control information, or any combination thereof associated with various information channels (e.g., control channels, data channels, information channels related to group-common bandwidth part switching). In some examples, the transmitter 1515 may be co-located with a receiver 1510 in a transceiver module. The transmitter 1515 may utilize a single antenna or a set of multiple antennas.

The communications manager 1520, the receiver 1510, the transmitter 1515, or various combinations thereof or various components thereof may be examples of means for performing various aspects of group-common bandwidth part switching as described herein. For example, the communications manager 1520, the receiver 1510, the transmitter 1515, or various combinations or components thereof may support a method for performing one or more of the functions described herein.

In some examples, the communications manager 1520, the receiver 1510, the transmitter 1515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1520, the receiver 1510, the transmitter 1515, or various combinations or components thereof may be implemented in code (e.g., as communications management software or firmware) executed by a processor. If implemented in code executed by a processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communication at a UE in accordance with examples as disclosed herein. For example, the communications manager 1520 may be configured as or otherwise support a means for communicating with a network entity on a first bandwidth part. The communications manager 1520 may be configured as or otherwise support a means for receiving a group-common downlink control information message indicating that the UE is to communicate with the network entity on a second bandwidth part, the group-common downlink control information message being for a set of multiple UEs including the UE. The communications manager 1520 may be configured as or otherwise support a means for communicating with the network entity on the second bandwidth part based on receiving the group-common downlink control information message.

By including or configuring the communications manager 1520 in accordance with examples as described herein, the device 1505 (e.g., a processor controlling or otherwise coupled with the receiver 1510, the transmitter 1515, the communications manager 1520, or a combination thereof) may support techniques for more efficient utilization of communication resources. Because the device 1505 may receive a GC-DCI triggering a BWP switch, a network entity may avoid transmitting UE-specific signaling to multiple UEs to trigger the BWP switch, resulting in the more efficient utilization of communication resources.

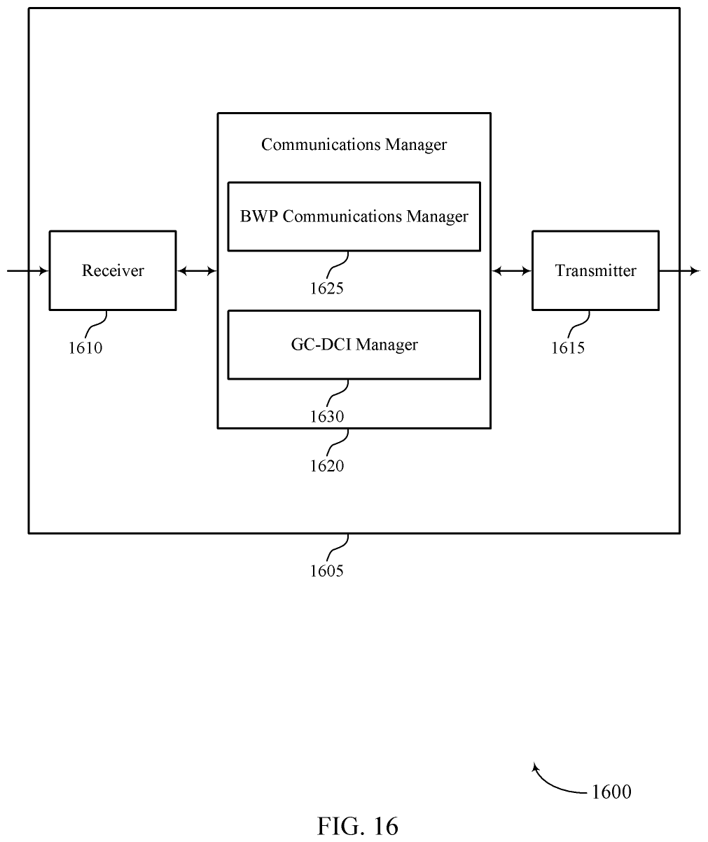

FIG. 16 shows a block diagram 1600 of a device 1605 that supports group-common bandwidth part switching in accordance with one or more aspects of the present disclosure. The device 1605 may be an example of aspects of a device 1505 or a UE 115 as described herein. The device 1605 may include a receiver 1610, a transmitter 1615, and a communications manager 1620. The device 1605 may also include a processor. Each of these components may be in communication with one another (e.g., via one or more buses).

The receiver 1610 may provide a means for receiving information such as packets, user data, control information, or any combination thereof associated with various information channels (e.g., control channels, data channels, information channels related to group-common bandwidth part switching). Information may be passed on to other components of the device 1605. The receiver 1610 may utilize a single antenna or a set of multiple antennas.

The transmitter 1615 may provide a means for transmitting signals generated by other components of the device 1605. For example, the transmitter 1615 may transmit information such as packets, user data, control information, or any combination thereof associated with various information channels (e.g., control channels, data channels, information channels related to group-common bandwidth part switching). In some examples, the transmitter 1615 may be co-located with a receiver 1610 in a transceiver module. The transmitter 1615 may utilize a single antenna or a set of multiple antennas.

The device 1605, or various components thereof, may be an example of means for performing various aspects of group-common bandwidth part switching as described herein. For example, the communications manager 1620 may include a BWP communications manager 1625 a GC-DCI manager 1630, or any combination thereof. The communications manager 1620 may be an example of aspects of a communications manager 1520 as described herein. In some examples, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communication at a UE in accordance with examples as disclosed herein. The BWP communications manager 1625 may be configured as or otherwise support a means for communicating with a network entity on a first bandwidth part. The GC-DCI manager 1630 may be configured as or otherwise support a means for receiving a group-common downlink control information message indicating that the UE is to communicate with the network entity on a second bandwidth part, the group-common downlink control information message being for a set of multiple UEs including the UE. The BWP communications manager 1625 may be configured as or otherwise support a means for communicating with the network entity on the second bandwidth part based on receiving the group-common downlink control information message.

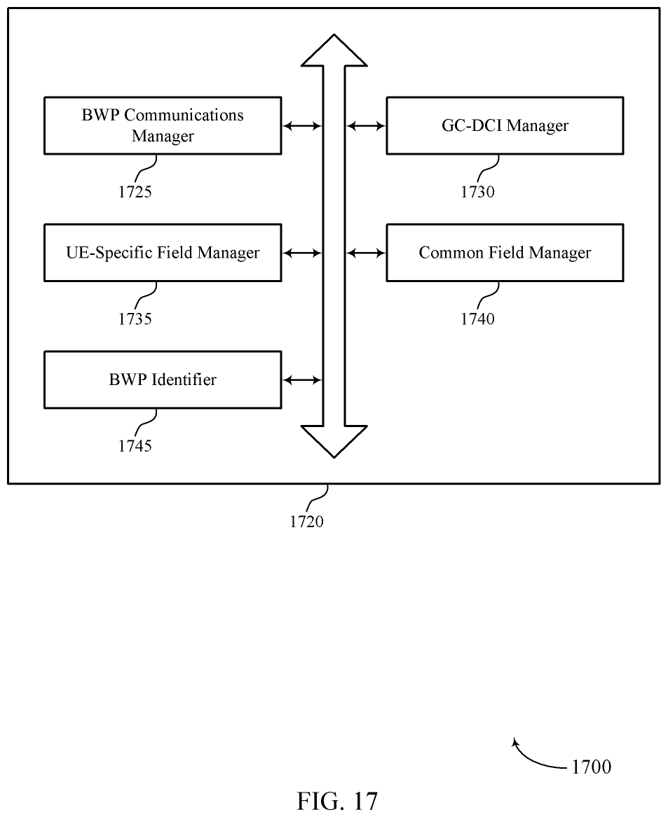

FIG. 17 shows a block diagram 1700 of a communications manager 1720 that supports group-common bandwidth part switching in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of group-common bandwidth part switching as described herein. For example, the communications manager 1720 may include a BWP communications manager 1725, a GC-DCI manager 1730, a UE-specific field manager 1735, a common field manager 1740, a BWP identifier 1745, or any combination thereof. Each of these components may communicate, directly or indirectly, with one another (e.g., via one or more buses).

The communications manager 1720 may support wireless communication at a UE in accordance with examples as disclosed herein. The BWP communications manager 1725 may be configured as or otherwise support a means for communicating with a network entity on a first bandwidth part. The GC-DCI manager 1730 may be configured as or otherwise support a means for receiving a group-common downlink control information message indicating that the UE is to communicate with the network entity on a second bandwidth part, the group-common downlink control information message being for a set of multiple UEs including the UE. In some examples, the BWP communications manager 1725 may be configured as or otherwise support a means for communicating with the network entity on the second bandwidth part based on receiving the group-common downlink control information message.

In some examples, the UE-specific field manager 1735 may be configured as or otherwise support a means for identifying, in the group-common downlink control information message, a UE-specific field for the UE indicating the second bandwidth part on which to communicate with the network entity.

In some examples, the common field manager 1740 may be configured as or otherwise support a means for identifying, in the group-common downlink control information message, a common field for the set of multiple UEs indicating the second bandwidth part on which to communicate with the network entity.

In some examples, the BWP identifier 1745 may be configured as or otherwise support a means for identifying the second bandwidth part on which to communicate with the network entity based on an implicit indication of the second bandwidth part in the group-common downlink control information message.

In some examples, the BWP identifier 1745 may be configured as or otherwise support a means for identifying the second bandwidth part on which to communicate with the network entity based on a bandwidth part switching pattern.

In some examples, the GC-DCI manager 1730 may be configured as or otherwise support a means for receiving the group-common downlink control information message indicating that the UE is to communicate with the network entity on the second bandwidth part based on the UE being restricted from communicating on the first bandwidth part.

In some examples, the UE communicates with the network entity on the first bandwidth part using frequency division duplexing in a full-duplex mode, and the UE communicates with the network entity on the second bandwidth part using time-division duplexing in a half-duplex mode.

In some examples, the UE communicates with the network entity on the first bandwidth part using time-division duplexing in a half-duplex mode, and the UE communicates with the network entity on the second bandwidth part using frequency-division duplexing in a full-duplex mode.

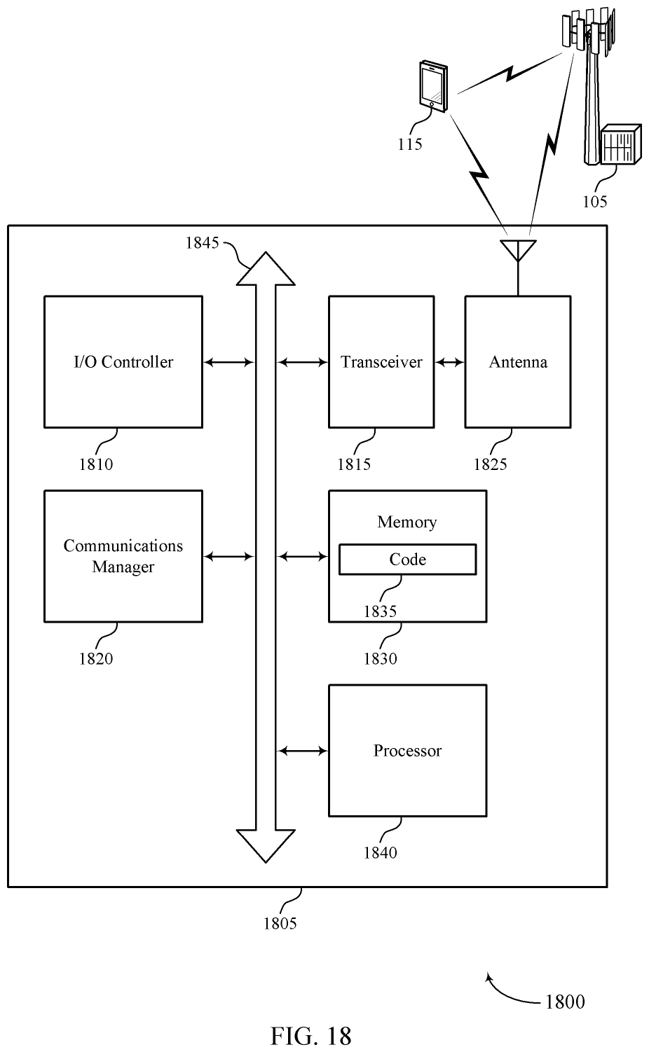

FIG. 18 shows a diagram of a system 1800 including a device 1805 that supports group-common bandwidth part switching in accordance with one or more aspects of the present disclosure. The device 1805 may be an example of or include the components of a device 1505, a device 1605, or a UE 115 as described herein. The device 1805 may communicate (e.g., wirelessly) with one or more network entities 105, one or more UEs 115, or any combination thereof. The device 1805 may include components for bi-directional voice and data communications including components for transmitting and receiving communications, such as a communications manager 1820, an input/output (I/O) controller 1810, a transceiver 1815, an antenna 1825, a memory 1830, code 1835, and a processor 1840. These components may be in electronic communication or otherwise coupled (e.g., operatively, communicatively, functionally, electronically, electrically) via one or more buses (e.g., a bus 1845).

The I/O controller 1810 may manage input and output signals for the device 1805. The I/O controller 1810 may also manage peripherals not integrated into the device 1805. In some cases, the I/O controller 1810 may represent a physical connection or port to an external peripheral. In some cases, the I/O controller 1810 may utilize an operating system such as iOSR, ANDROIDR, MS-DOSR, MS-WINDOWS®, OS/2R, UNIX, LINUXR, or another known operating system. Additionally or alternatively, the I/O controller 1810 may represent or interact with a modem, a keyboard, a mouse, a touchscreen, or a similar device. In some cases, the I/O controller 1810 may be implemented as part of a processor, such as the processor 1840. In some cases, a user may interact with the device 1805 via the I/O controller 1810 or via hardware components controlled by the I/O controller 1810.

In some cases, the device 1805 may include a single antenna 1825. However, in some other cases, the device 1805 may have more than one antenna 1825, which may be capable of concurrently transmitting or receiving multiple wireless transmissions. The transceiver 1815 may communicate bi-directionally, via the one or more antennas 1825, wired, or wireless links as described herein. For example, the transceiver 1815 may represent a wireless transceiver and may communicate bi-directionally with another wireless transceiver. The transceiver 1815 may also include a modem to modulate the packets, to provide the modulated packets to one or more antennas 1825 for transmission, and to demodulate packets received from the one or more antennas 1825. The transceiver 1815, or the transceiver 1815 and one or more antennas 1825, may be an example of a transmitter 1515, a transmitter 1615, a receiver 1510, a receiver 1610, or any combination thereof or component thereof, as described herein.

The memory 1830 may include random access memory (RAM) and read-only memory (ROM). The memory 1830 may store computer-readable, computer-executable code 1835 including instructions that, when executed by the processor 1840, cause the device 1805 to perform various functions described herein. The code 1835 may be stored in a non-transitory computer-readable medium such as system memory or another type of memory. In some cases, the code 1835 may not be directly executable by the processor 1840 but may cause a computer (e.g., when compiled and executed) to perform functions described herein. In some cases, the memory 1830 may contain, among other things, a basic I/O system (BIOS) which may control basic hardware or software operation such as the interaction with peripheral components or devices.

The processor 1840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1840 may be configured to operate a memory array using a memory controller. In some other cases, a memory controller may be integrated into the processor 1840. The processor 1840 may be configured to execute computer-readable instructions stored in a memory (e.g., the memory 1830) to cause the device 1805 to perform various functions (e.g., functions or tasks supporting group-common bandwidth part switching). For example, the device 1805 or a component of the device 1805 may include a processor 1840 and memory 1830 coupled with or to the processor 1840, the processor 1840 and memory 1830 configured to perform various functions described herein.

The communications manager 1820 may support wireless communication at a UE in accordance with examples as disclosed herein. For example, the communications manager 1820 may be configured as or otherwise support a means for communicating with a network entity on a first bandwidth part. The communications manager 1820 may be configured as or otherwise support a means for receiving a group-common downlink control information message indicating that the UE is to communicate with the network entity on a second bandwidth part, the group-common downlink control information message being for a set of multiple UEs including the UE. The communications manager 1820 may be configured as or otherwise support a means for communicating with the network entity on the second bandwidth part based on receiving the group-common downlink control information message.

By including or configuring the communications manager 1820 in accordance with examples as described herein, the device 1805 may support techniques for more efficient utilization of communication resources. Because the device 1805 may receive a GC-DCI triggering a BWP switch, a network entity may avoid transmitting UE-specific signaling to multiple UEs to trigger the BWP switch, resulting in the more efficient utilization of communication resources.

In some examples, the communications manager 1820 may be configured to perform various operations (e.g., receiving, monitoring, transmitting) using or otherwise in cooperation with the transceiver 1815, the one or more antennas 1825, or any combination thereof. Although the communications manager 1820 is illustrated as a separate component, in some examples, one or more functions described with reference to the communications manager 1820 may be supported by or performed by the processor 1840, the memory 1830, the code 1835, or any combination thereof. For example, the code 1835 may include instructions executable by the processor 1840 to cause the device 1805 to perform various aspects of group-common bandwidth part switching as described herein, or the processor 1840 and the memory 1830 may be otherwise configured to perform or support such operations.

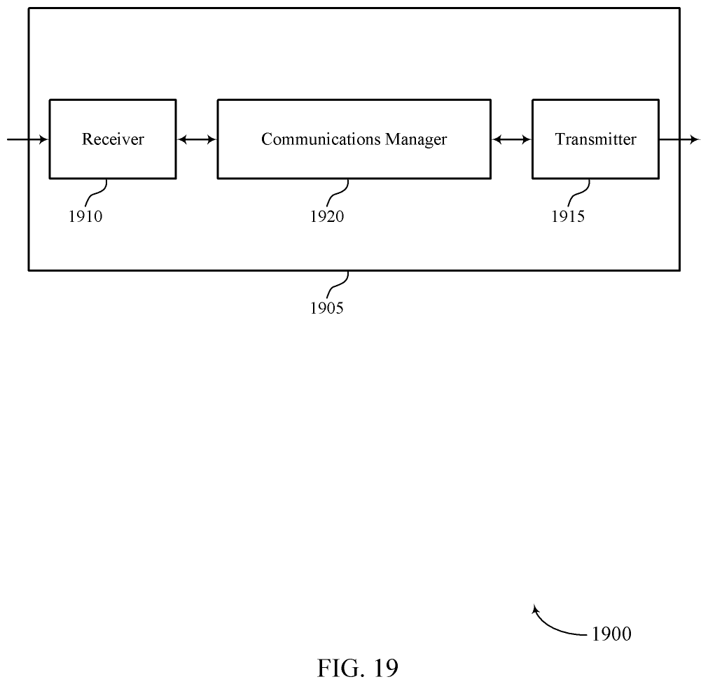

FIG. 19 shows a block diagram 1900 of a device 1905 that supports group-common bandwidth part switching in accordance with one or more aspects of the present disclosure. The device 1905 may be an example of aspects of a network entity 105 as described herein. The device 1905 may include a receiver 1910, a transmitter 1915, and a communications manager 1920. The device 1905 may also include a processor. Each of these components may be in communication with one another (e.g., via one or more buses).

The receiver 1910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1905. In some examples, the receiver 1910 may support obtaining information by receiving signals via one or more antennas. Additionally, or alternatively, the receiver 1910 may support obtaining information by receiving signals via one or more wired (e.g., electrical, fiber optic) interfaces, wireless interfaces, or any combination thereof.

The transmitter 1915 may provide a means for outputting (e.g., transmitting, providing, conveying, sending) information generated by other components of the device 1905. For example, the transmitter 1915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1915 may support outputting information by transmitting signals via one or more antennas. Additionally, or alternatively, the transmitter 1915 may support outputting information by transmitting signals via one or more wired (e.g., electrical, fiber optic) interfaces, wireless interfaces, or any combination thereof. In some examples, the transmitter 1915 and the receiver 1910 may be co-located in a transceiver, which may include or be coupled with a modem.

The communications manager 1920, the receiver 1910, the transmitter 1915, or various combinations thereof or various components thereof may be examples of means for performing various aspects of group-common bandwidth part switching as described herein. For example, the communications manager 1920, the receiver 1910, the transmitter 1915, or various combinations or components thereof may support a method for performing one or more of the functions described herein.

In some examples, the communications manager 1920, the receiver 1910, the transmitter 1915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1920, the receiver 1910, the transmitter 1915, or various combinations or components thereof may be implemented in code (e.g., as communications management software or firmware) executed by a processor. If implemented in code executed by a processor, the functions of the communications manager 1920, the receiver 1910, the transmitter 1915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1920 may be configured to perform various operations (e.g., receiving, obtaining, monitoring, outputting, transmitting) using or otherwise in cooperation with the receiver 1910, the transmitter 1915, or both. For example, the communications manager 1920 may receive information from the receiver 1910, send information to the transmitter 1915, or be integrated in combination with the receiver 1910, the transmitter 1915, or both to obtain information, output information, or perform various other operations as described herein.

The communications manager 1920 may support wireless communication at a network entity in accordance with examples as disclosed herein. For example, the communications manager 1920 may be configured as or otherwise support a means for communicating with a UE on a first bandwidth part. The communications manager 1920 may be configured as or otherwise support a means for transmitting a group-common downlink control information message indicating that the UE is to communicate with the network entity on a second bandwidth part, the group-common downlink control information message being for a set of multiple UEs including the UE. The communications manager 1920 may be configured as or otherwise support a means for communicating with the UE on the second bandwidth part based on transmitting the group-common downlink control information message.

By including or configuring the communications manager 1920 in accordance with examples as described herein, the device 1905 (e.g., a processor controlling or otherwise coupled with the receiver 1910, the transmitter 1915, the communications manager 1920, or a combination thereof) may support techniques for reduced processing, reduced power consumption, and more efficient utilization of communication resources. Because the device 1905 may use a GC-DCI to trigger a BWP switch at one or more UEs, the device 1905 may avoid generating and transmitting UE-specific signaling to trigger the BWP switch, resulting in the reduced processing, reduced power consumption, and more efficient utilization of communication resources.

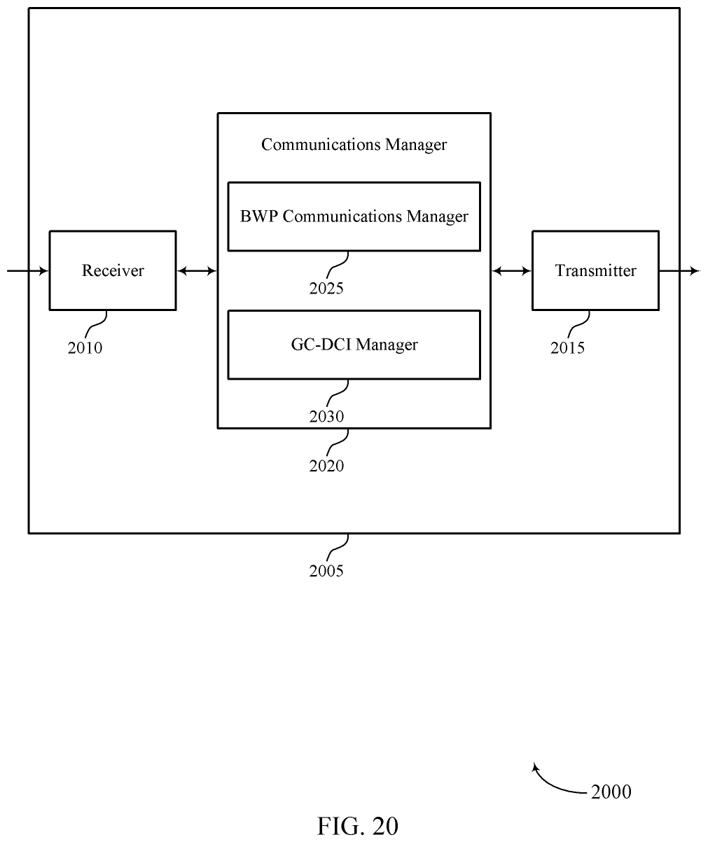

FIG. 20 shows a block diagram 2000 of a device 2005 that supports group-common bandwidth part switching in accordance with one or more aspects of the present disclosure. The device 2005 may be an example of aspects of a device 1905 or a network entity 105 as described herein. The device 2005 may include a receiver 2010, a transmitter 2015, and a communications manager 2020. The device 2005 may also include a processor. Each of these components may be in communication with one another (e.g., via one or more buses).

The receiver 2010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 2005. In some examples, the receiver 2010 may support obtaining information by receiving signals via one or more antennas. Additionally, or alternatively, the receiver 2010 may support obtaining information by receiving signals via one or more wired (e.g., electrical, fiber optic) interfaces, wireless interfaces, or any combination thereof.

The transmitter 2015 may provide a means for outputting (e.g., transmitting, providing, conveying, sending) information generated by other components of the device 2005. For example, the transmitter 2015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 2015 may support outputting information by transmitting signals via one or more antennas. Additionally, or alternatively, the transmitter 2015 may support outputting information by transmitting signals via one or more wired (e.g., electrical, fiber optic) interfaces, wireless interfaces, or any combination thereof. In some examples, the transmitter 2015 and the receiver 2010 may be co-located in a transceiver, which may include or be coupled with a modem.

The device 2005, or various components thereof, may be an example of means for performing various aspects of group-common bandwidth part switching as described herein. For example, the communications manager 2020 may include a BWP communications manager 2025 a GC-DCI manager 2030, or any combination thereof. The communications manager 2020 may be an example of aspects of a communications manager 1920 as described herein. In some examples, the communications manager 2020, or various components thereof, may be configured to perform various operations (e.g., receiving, obtaining, monitoring, outputting, transmitting) using or otherwise in cooperation with the receiver 2010, the transmitter 2015, or both. For example, the communications manager 2020 may receive information from the receiver 2010, send information to the transmitter 2015, or be integrated in combination with the receiver 2010, the transmitter 2015, or both to obtain information, output information, or perform various other operations as described herein.

The communications manager 2020 may support wireless communication at a network entity in accordance with examples as disclosed herein. The BWP communications manager 2025 may be configured as or otherwise support a means for communicating with a UE on a first bandwidth part. The GC-DCI manager 2030 may be configured as or otherwise support a means for transmitting a group-common downlink control information message indicating that the UE is to communicate with the network entity on a second bandwidth part, the group-common downlink control information message being for a set of multiple UEs including the UE. The BWP communications manager 2025 may be configured as or otherwise support a means for communicating with the UE on the second bandwidth part based on transmitting the group-common downlink control information message.

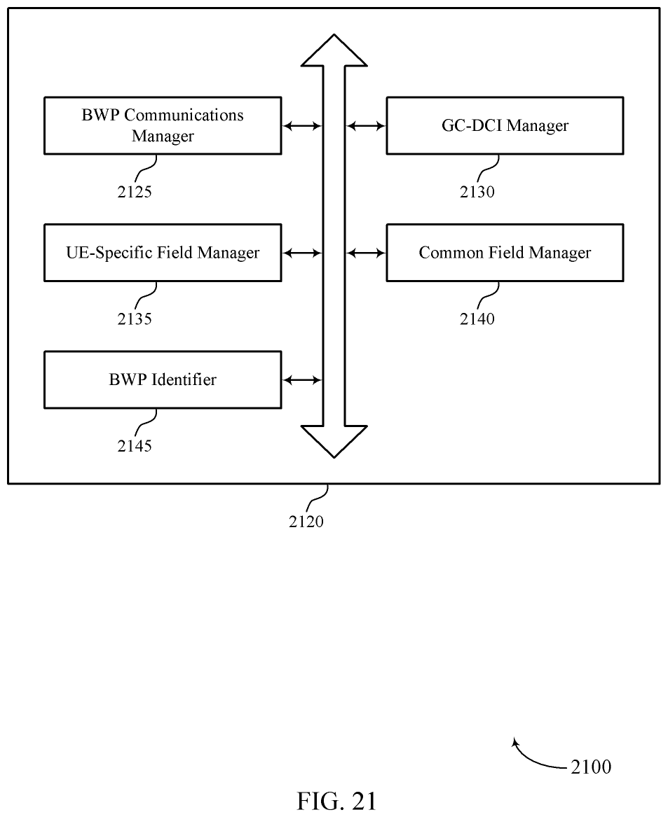

FIG. 21 shows a block diagram 2100 of a communications manager 2120 that supports group-common bandwidth part switching in accordance with one or more aspects of the present disclosure. The communications manager 2120 may be an example of aspects of a communications manager 1920, a communications manager 2020, or both, as described herein. The communications manager 2120, or various components thereof, may be an example of means for performing various aspects of group-common bandwidth part switching as described herein. For example, the communications manager 2120 may include a BWP communications manager 2125, a GC-DCI manager 2130, a UE-specific field manager 2135, a common field manager 2140, a BWP identifier 2145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 2120 may support wireless communication at a network entity in accordance with examples as disclosed herein. The BWP communications manager 2125 may be configured as or otherwise support a means for communicating with a UE on a first bandwidth part. The GC-DCI manager 2130 may be configured as or otherwise support a means for transmitting a group-common downlink control information message indicating that the UE is to communicate with the network entity on a second bandwidth part, the group-common downlink control information message being for a set of multiple UEs including the UE. In some examples, the BWP communications manager 2125 may be configured as or otherwise support a means for communicating with the UE on the second bandwidth part based on transmitting the group-common downlink control information message.

In some examples, to support transmitting the group-common downlink control information message, the UE-specific field manager 2135 may be configured as or otherwise support a means for transmitting, in the group-common downlink control information message, a UE-specific field for the UE indicating the second bandwidth part on which the UE is to communicate with the network entity.

In some examples, to support transmitting the group-common downlink control information message, the common field manager 2140 may be configured as or otherwise support a means for transmitting, in the group-common downlink control information message, a common field for the set of multiple UEs indicating the second bandwidth part on which the UE is to communicate with the network entity.

In some examples, the group-common downlink control information message implicitly indicates the second bandwidth part on which to communicate with the network entity.

In some examples, the BWP identifier 2145 may be configured as or otherwise support a means for identifying the second bandwidth part on which to communicate with the network entity based on a bandwidth part switching pattern.

In some examples, to support transmitting the group-common downlink control information message, the GC-DCI manager 2130 may be configured as or otherwise support a means for transmitting, in the group-common downlink control information message, the indication of the second bandwidth part on which the UE is to communicate with the network entity based on the UE being restricted from communicating on the first bandwidth part.

In some examples, the UE communicates with the network entity on the first bandwidth part using frequency division duplexing in a full-duplex mode, and the UE communicates with the network entity on the second bandwidth part using time-division duplexing in a half-duplex mode.

In some examples, the UE communicates with the network entity on the first bandwidth part using time-division duplexing in a half-duplex mode, and the UE communicates with the network entity on the second bandwidth part using frequency-division duplexing in a full-duplex mode.

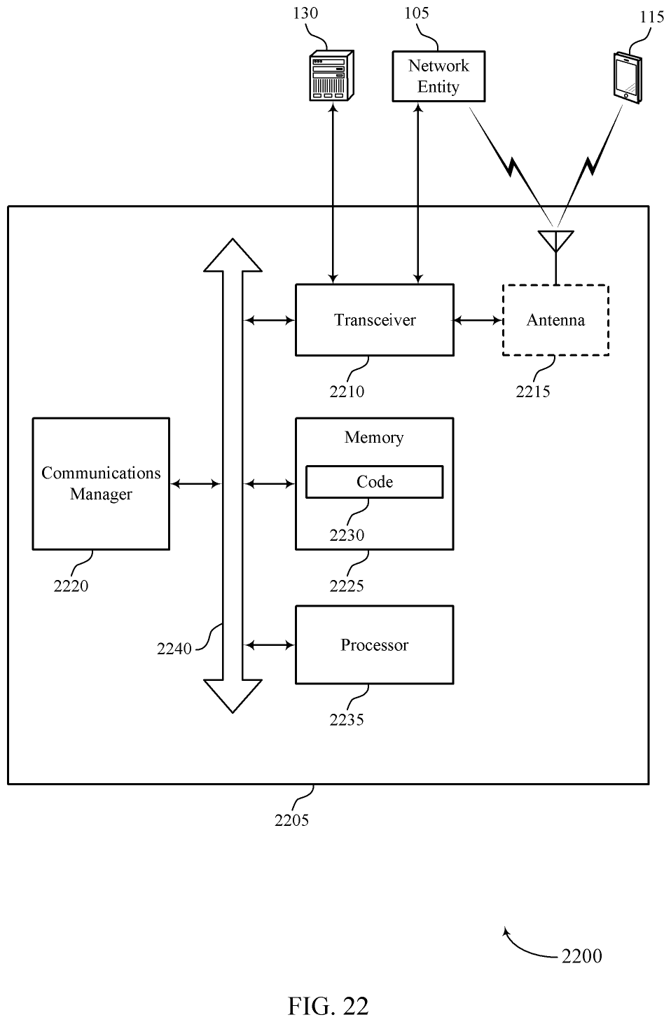

FIG. 22 shows a diagram of a system 2200 including a device 2205 that supports group-common bandwidth part switching in accordance with one or more aspects of the present disclosure. The device 2205 may be an example of or include the components of a device 1905, a device 2005, or a network entity 105 as described herein. The device 2205 may communicate with one or more network entities 105, one or more UEs 115, or any combination thereof, which may include communications over one or more wired interfaces, over one or more wireless interfaces, or any combination thereof. The device 2205 may include components that support outputting and obtaining communications, such as a communications manager 2220, a transceiver 2210, an antenna 2215, a memory 2225, code 2230, and a processor 2235. These components may be in electronic communication or otherwise coupled (e.g., operatively, communicatively, functionally, electronically, electrically) via one or more buses (e.g., a bus 2240).

The transceiver 2210 may support bi-directional communications via wired links, wireless links, or both as described herein. In some examples, the transceiver 2210 may include a wired transceiver and may communicate bi-directionally with another wired transceiver. Additionally, or alternatively, in some examples, the transceiver 2210 may include a wireless transceiver and may communicate bi-directionally with another wireless transceiver. In some examples, the device 2205 may include one or more antennas 2215, which may be capable of transmitting or receiving wireless transmissions (e.g., concurrently). The transceiver 2210 may also include a modem to modulate signals, to provide the modulated signals for transmission (e.g., by one or more antennas 2215, by a wired transmitter), to receive modulated signals (e.g., from one or more antennas 2215, from a wired receiver), and to demodulate signals. The transceiver 2210, or the transceiver 2210 and one or more antennas 2215 or wired interfaces, where applicable, may be an example of a transmitter 1915, a transmitter 2015, a receiver 1910, a receiver 2010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 2225 may include RAM and ROM. The memory 2225 may store computer-readable, computer-executable code 2230 including instructions that, when executed by the processor 2235, cause the device 2205 to perform various functions described herein. The code 2230 may be stored in a non-transitory computer-readable medium such as system memory or another type of memory. In some cases, the code 2230 may not be directly executable by the processor 2235 but may cause a computer (e.g., when compiled and executed) to perform functions described herein. In some cases, the memory 2225 may contain, among other things, a BIOS which may control basic hardware or software operation such as the interaction with peripheral components or devices.

The processor 2235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 2235 may be configured to operate a memory array using a memory controller. In some other cases, a memory controller may be integrated into the processor 2235. The processor 2235 may be configured to execute computer-readable instructions stored in a memory (e.g., the memory 2225) to cause the device 2205 to perform various functions (e.g., functions or tasks supporting group-common bandwidth part switching). For example, the device 2205 or a component of the device 2205 may include a processor 2235 and memory 2225 coupled with the processor 2235, the processor 2235 and memory 2225 configured to perform various functions described herein. The processor 2235 may be an example of a cloud-computing platform (e.g., one or more physical nodes and supporting software such as operating systems, virtual machines, or container instances) that may host the functions (e.g., by executing code 2230) to perform the functions of the device 2205.

In some examples, a bus 2240 may support communications of (e.g., within) a protocol layer of a protocol stack. In some examples, a bus 2240 may support communications associated with a logical channel of a protocol stack (e.g., between protocol layers of a protocol stack), which may include communications performed within a component of the device 2205, or between different components of the device 2205 that may be co-located or located in different locations (e.g., where the device 2205 may refer to a system in which one or more of the communications manager 2220, the transceiver 2210, the memory 2225, the code 2230, and the processor 2235 may be located in one of the different components or divided between different components).

In some examples, the communications manager 2220 may manage aspects of communications with a core network 130 (e.g., via one or more wired or wireless backhaul links). For example, the communications manager 2220 may manage the transfer of data communications for client devices, such as one or more UEs 115. In some examples, the communications manager 2220 may manage communications with other network entities 105, and may include a controller or scheduler for controlling communications with UEs 115 in cooperation with other network entities 105. In some examples, the communications manager 2220 may support an X2 interface within an LTE/LTE-A wireless communications network technology to provide communication between network entities 105.

The communications manager 2220 may support wireless communication at a network entity in accordance with examples as disclosed herein. For example, the communications manager 2220 may be configured as or otherwise support a means for communicating with a UE on a first bandwidth part. The communications manager 2220 may be configured as or otherwise support a means for transmitting a group-common downlink control information message indicating that the UE is to communicate with the network entity on a second bandwidth part, the group-common downlink control information message being for a set of multiple UEs including the UE. The communications manager 2220 may be configured as or otherwise support a means for communicating with the UE on the second bandwidth part based on transmitting the group-common downlink control information message.

By including or configuring the communications manager 2220 in accordance with examples as described herein, the device 2205 may support techniques for reduced processing, reduced power consumption, and more efficient utilization of communication resources. Because the device 2205 may use a GC-DCI to trigger a BWP switch at one or more UEs, the device 2205 may avoid generating and transmitting UE-specific signaling to trigger the BWP switch, resulting in the reduced processing, reduced power consumption, and more efficient utilization of communication resources.

In some examples, the communications manager 2220 may be configured to perform various operations (e.g., receiving, obtaining, monitoring, outputting, transmitting) using or otherwise in cooperation with the transceiver 2210, the one or more antennas 2215 (e.g., where applicable), or any combination thereof. Although the communications manager 2220 is illustrated as a separate component, in some examples, one or more functions described with reference to the communications manager 2220 may be supported by or performed by the processor 2235, the memory 2225, the code 2230, the transceiver 2210, or any combination thereof. For example, the code 2230 may include instructions executable by the processor 2235 to cause the device 2205 to perform various aspects of group-common bandwidth part switching as described herein, or the processor 2235 and the memory 2225 may be otherwise configured to perform or support such operations.

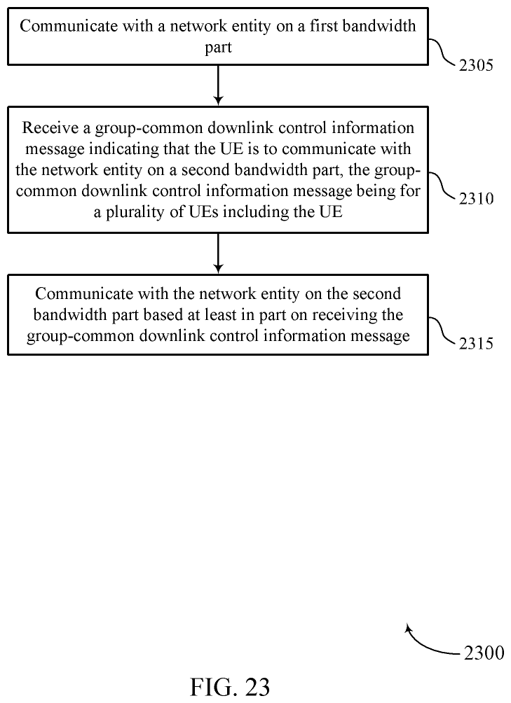

FIG. 23 shows a flowchart illustrating a method 2300 that supports group-common bandwidth part switching in accordance with one or more aspects of the present disclosure. The operations of the method 2300 may be implemented by a UE or its components as described herein. For example, the operations of the method 2300 may be performed by a UE 115 as described with reference to FIGS. 1 through 18. In some examples, a UE may execute a set of instructions to control the functional elements of the UE to perform the described functions. Additionally, or alternatively, the UE may perform aspects of the described functions using special-purpose hardware.

At 2305, the method may include communicating with a network entity on a first bandwidth part. The operations of 2305 may be performed in accordance with examples as disclosed herein. In some examples, aspects of the operations of 2305 may be performed by a BWP communications manager 1725 as described with reference to FIG. 17.

At 2310, the method may include receiving a group-common downlink control information message indicating that the UE is to communicate with the network entity on a second bandwidth part, the group-common downlink control information message being for a set of multiple UEs including the UE. The operations of 2310 may be performed in accordance with examples as disclosed herein. In some examples, aspects of the operations of 2310 may be performed by a GC-DCI manager 1730 as described with reference to FIG. 17.

At 2315, the method may include communicating with the network entity on the second bandwidth part based on receiving the group-common downlink control information message. The operations of 2315 may be performed in accordance with examples as disclosed herein. In some examples, aspects of the operations of 2315 may be performed by a BWP communications manager 1725 as described with reference to FIG. 17.

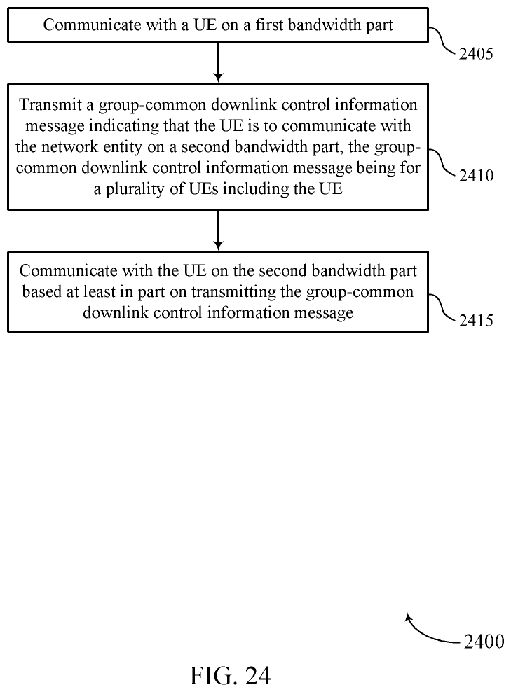

FIG. 24 shows a flowchart illustrating a method 2400 that supports group-common bandwidth part switching in accordance with one or more aspects of the present disclosure. The operations of the method 2400 may be implemented by a network entity or its components as described herein. For example, the operations of the method 2400 may be performed by a network entity as described with reference to FIGS. 1 through 14 and 19 through 22. In some examples, a network entity may execute a set of instructions to control the functional elements of the network entity to perform the described functions. Additionally, or alternatively, the network entity may perform aspects of the described functions using special-purpose hardware.

At 2405, the method may include communicating with a UE on a first bandwidth part. The operations of 2405 may be performed in accordance with examples as disclosed herein. In some examples, aspects of the operations of 2405 may be performed by a BWP communications manager 2125 as described with reference to FIG. 21.

At 2410, the method may include transmitting a group-common downlink control information message indicating that the UE is to communicate with the network entity on a second bandwidth part, the group-common downlink control information message being for a set of multiple UEs including the UE. The operations of 2410 may be performed in accordance with examples as disclosed herein. In some examples, aspects of the operations of 2410 may be performed by a GC-DCI manager 2130 as described with reference to FIG. 21.

At 2415, the method may include communicating with the UE on the second bandwidth part based on transmitting the group-common downlink control information message. The operations of 2415 may be performed in accordance with examples as disclosed herein. In some examples, aspects of the operations of 2415 may be performed by a BWP communications manager 2125 as described with reference to FIG. 21.

The following provides an overview of aspects of the present disclosure:
Aspect 1: A method for wireless communication at a UE, comprising: communicating with a network entity on a first bandwidth part; receiving a group-common downlink control information message indicating that the UE is to communicate with the network entity on a second bandwidth part, the group-common downlink control information message being for a plurality of UEs including the UE; and communicating with the network entity on the second bandwidth part based at least in part on receiving the group-common downlink control information message.
Aspect 2: The method of aspect 1, further comprising: identifying, in the group-common downlink control information message, a UE-specific field for the UE indicating the second bandwidth part on which to communicate with the network entity.
Aspect 3: The method of any of aspects 1 through 2, further comprising: identifying, in the group-common downlink control information message, a common field for the plurality of UEs indicating the second bandwidth part on which to communicate with the network entity.
Aspect 4: The method of any of aspects 1 through 3, further comprising: identifying the second bandwidth part on which to communicate with the network entity based at least in part on an implicit indication of the second bandwidth part in the group-common downlink control information message.
Aspect 5: The method of any of aspects 1 through 4, further comprising: identifying the second bandwidth part on which to communicate with the network entity based at least in part on a bandwidth part switching pattern.
Aspect 6: The method of any of aspects 1 through 5, further comprising: receiving the group-common downlink control information message indicating that the UE is to communicate with the network entity on the second bandwidth part based at least in part on the UE being restricted from communicating on the first bandwidth part.
Aspect 7: The method of any of aspects 1 through 6, wherein the UE communicates with the network entity on the first bandwidth part using frequency division duplexing in a full-duplex mode, and the UE communicates with the network entity on the second bandwidth part using time-division duplexing in a half-duplex mode.
Aspect 8: The method of any of aspects 1 through 7, wherein the UE communicates with the network entity on the first bandwidth part using time-division duplexing in a half-duplex mode, and the UE communicates with the network entity on the second bandwidth part using frequency-division duplexing in a full-duplex mode.
Aspect 9: A method for wireless communication at a network entity, comprising: communicating with a UE on a first bandwidth part; transmitting a group-common downlink control information message indicating that the UE is to communicate with the network entity on a second bandwidth part, the group-common downlink control information message being for a plurality of UEs including the UE; and communicating with the UE on the second bandwidth part based at least in part on transmitting the group-common downlink control information message.
Aspect 10: The method of aspect 9, wherein transmitting the group-common downlink control information message comprises: transmitting, in the group-common downlink control information message, a UE-specific field for the UE indicating the second bandwidth part on which the UE is to communicate with the network entity.
Aspect 11: The method of any of aspects 9 through 10, wherein transmitting the group-common downlink control information message comprises: transmitting, in the group-common downlink control information message, a common field for the plurality of UEs indicating the second bandwidth part on which the UE is to communicate with the network entity.
Aspect 12: The method of any of aspects 9 through 11, wherein the group-common downlink control information message implicitly indicates the second bandwidth part on which to communicate with the network entity.
Aspect 13: The method of any of aspects 9 through 12, further comprising: identifying the second bandwidth part on which to communicate with the network entity based at least in part on a bandwidth part switching pattern.
Aspect 14: The method of any of aspects 9 through 13, wherein transmitting the group-common downlink control information message comprises: transmitting, in the group-common downlink control information message, the indication of the second bandwidth part on which the UE is to communicate with the network entity based at least in part on the UE being restricted from communicating on the first bandwidth part.
Aspect 15: The method of any of aspects 9 through 14, wherein the UE communicates with the network entity on the first bandwidth part using frequency division duplexing in a full-duplex mode, and the UE communicates with the network entity on the second bandwidth part using time-division duplexing in a half-duplex mode.
Aspect 16: The method of any of aspects 9 through 15, wherein the UE communicates with the network entity on the first bandwidth part using time-division duplexing in a half-duplex mode, and the UE communicates with the network entity on the second bandwidth part using frequency-division duplexing in a full-duplex mode.
Aspect 17: An apparatus for wireless communication at a UE, comprising a processor; memory coupled with the processor; and instructions stored in the memory and executable by the processor to cause the apparatus to perform a method of any of aspects 1 through 8.
Aspect 18: An apparatus for wireless communication at a UE, comprising at least one means for performing a method of any of aspects 1 through 8.
Aspect 19: A non-transitory computer-readable medium storing code for wireless communication at a UE, the code comprising instructions executable by a processor to perform a method of any of aspects 1 through 8.
Aspect 20: An apparatus for wireless communication at a network entity, comprising a processor; memory coupled with the processor; and instructions stored in the memory and executable by the processor to cause the apparatus to perform a method of any of aspects 9 through 16.
Aspect 21: An apparatus for wireless communication at a network entity, comprising at least one means for performing a method of any of aspects 9 through 16.
Aspect 22: A non-transitory computer-readable medium storing code for wireless communication at a network entity, the code comprising instructions executable by a processor to perform a method of any of aspects 9 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
communicate with a network entity on a first bandwidth part;
receive a group-common downlink control information message indicating that the UE is to communicate with the network entity on a second bandwidth part, the group-common downlink control information message being for a plurality of UEs including the UE; and
communicate with the network entity on the second bandwidth part based at least in part on receiving the group-common downlink control information message.

2. The apparatus of claim 1, wherein the instructions are further executable by the processor to cause the apparatus to:
identify, in the group-common downlink control information message, a UE-specific field for the UE indicating the second bandwidth part on which to communicate with the network entity.

3. The apparatus of claim 1, wherein the instructions are further executable by the processor to cause the apparatus to:
identify, in the group-common downlink control information message, a common field for the plurality of UEs indicating the second bandwidth part on which to communicate with the network entity.

4. The apparatus of claim 1, wherein the instructions are further executable by the processor to cause the apparatus to:
identify the second bandwidth part on which to communicate with the network entity based at least in part on an implicit indication of the second bandwidth part in the group-common downlink control information message.

5. The apparatus of claim 1, wherein the instructions are further executable by the processor to cause the apparatus to:
identify the second bandwidth part on which to communicate with the network entity based at least in part on a bandwidth part switching pattern.

6. The apparatus of claim 1, wherein the instructions are further executable by the processor to cause the apparatus to:
receive the group-common downlink control information message indicating that the UE is to communicate with the network entity on the second bandwidth part based at least in part on the UE being restricted from communicating on the first bandwidth part.

7. The apparatus of claim 1, wherein the UE communicates with the network entity on the first bandwidth part using frequency division duplexing in a full-duplex mode, and the UE communicates with the network entity on the second bandwidth part using time-division duplexing in a half-duplex mode.

8. The apparatus of claim 1, wherein the UE communicates with the network entity on the first bandwidth part using time-division duplexing in a half-duplex mode, and the UE communicates with the network entity on the second bandwidth part using frequency-division duplexing in a full-duplex mode.

9. An apparatus for wireless communication at a network entity, comprising:
a processor;
memory coupled with the processor; and
instructions stored in the memory and executable by the processor to cause the apparatus to:
communicate with a user equipment (UE) on a first bandwidth part;
transmit a group-common downlink control information message indicating that the UE is to communicate with the network entity on a second bandwidth part, the group-common downlink control information message being for a plurality of UEs including the UE; and
communicate with the UE on the second bandwidth part based at least in part on transmitting the group-common downlink control information message.

10. The apparatus of claim 9, wherein the instructions to transmit the group-common downlink control information message are executable by the processor to cause the apparatus to:
transmit, in the group-common downlink control information message, a UE-specific field for the UE indicating the second bandwidth part on which the UE is to communicate with the network entity.

11. The apparatus of claim 9, wherein the instructions to transmit the group-common downlink control information message are executable by the processor to cause the apparatus to:
transmit, in the group-common downlink control information message, a common field for the plurality of UEs indicating the second bandwidth part on which the UE is to communicate with the network entity.

12. The apparatus of claim 9, wherein the group-common downlink control information message implicitly indicates the second bandwidth part on which to communicate with the network entity.

13. The apparatus of claim 9, wherein the instructions are further executable by the processor to cause the apparatus to:
identify the second bandwidth part on which to communicate with the network entity based at least in part on a bandwidth part switching pattern.

14. The apparatus of claim 9, wherein the instructions to transmit the group-common downlink control information message are executable by the processor to cause the apparatus to:
transmit, in the group-common downlink control information message, the indication of the second bandwidth part on which the UE is to communicate with the network entity based at least in part on the UE being restricted from communicating on the first bandwidth part.

15. The apparatus of claim 9, wherein the UE communicates with the network entity on the first bandwidth part using frequency division duplexing in a full-duplex mode, and the UE communicates with the network entity on the second bandwidth part using time-division duplexing in a half-duplex mode.

16. The apparatus of claim 9, wherein the UE communicates with the network entity on the first bandwidth part using time-division duplexing in a half-duplex mode, and the UE communicates with the network entity on the second bandwidth part using frequency-division duplexing in a full-duplex mode.

17. A method for wireless communication at a user equipment (UE), comprising:
communicating with a network entity on a first bandwidth part;
receiving a group-common downlink control information message indicating that the UE is to communicate with the network entity on a second bandwidth part, the group-common downlink control information message being for a plurality of UEs including the UE; and
communicating with the network entity on the second bandwidth part based at least in part on receiving the group-common downlink control information message.

18. The method of claim 17, further comprising:
identifying, in the group-common downlink control information message, a UE-specific field for the UE indicating the second bandwidth part on which to communicate with the network entity.

19. The method of claim 17, further comprising:
identifying, in the group-common downlink control information message, a common field for the plurality of UEs indicating the second bandwidth part on which to communicate with the network entity.

20. The method of claim 17, further comprising:
identifying the second bandwidth part on which to communicate with the network entity based at least in part on an implicit indication of the second bandwidth part in the group-common downlink control information message.

21. The method of claim 17, further comprising:
identifying the second bandwidth part on which to communicate with the network entity based at least in part on a bandwidth part switching pattern.

22. The method of claim 17, further comprising:
receiving the group-common downlink control information message indicating that the UE is to communicate with the network entity on the second bandwidth part based at least in part on the UE being restricted from communicating on the first bandwidth part.

23. The method of claim 17, wherein the UE communicates with the network entity on the first bandwidth part using frequency division duplexing in a full-duplex mode, and the UE communicates with the network entity on the second bandwidth part using time-division duplexing in a half-duplex mode.

24. The method of claim 17, wherein the UE communicates with the network entity on the first bandwidth part using time-division duplexing in a half-duplex mode, and the UE communicates with the network entity on the second bandwidth part using frequency-division duplexing in a full-duplex mode.

25. A method for wireless communication at a network entity, comprising:
communicating with a user equipment (UE) on a first bandwidth part;
transmitting a group-common downlink control information message indicating that the UE is to communicate with the network entity on a second bandwidth part, the group-common downlink control information message being for a plurality of UEs including the UE; and
communicating with the UE on the second bandwidth part based at least in part on transmitting the group-common downlink control information message.

26. The method of claim 25, wherein transmitting the group-common downlink control information message comprises:
transmitting, in the group-common downlink control information message, a UE-specific field for the UE indicating the second bandwidth part on which the UE is to communicate with the network entity.

27. The method of claim 25, wherein transmitting the group-common downlink control information message comprises:
transmitting, in the group-common downlink control information message, a common field for the plurality of UEs indicating the second bandwidth part on which the UE is to communicate with the network entity.

28. The method of claim 25, wherein the group-common downlink control information message implicitly indicates the second bandwidth part on which to communicate with the network entity.

29. The method of claim 25, further comprising:
identifying the second bandwidth part on which to communicate with the network entity based at least in part on a bandwidth part switching pattern.

30. The method of claim 25, wherein transmitting the group-common downlink control information message comprises:
transmitting, in the group-common downlink control information message, the indication of the second bandwidth part on which the UE is to communicate with the network entity based at least in part on the UE being restricted from communicating on the first bandwidth part.
